(19) United States
(12) Patent Application Publication
(10) Pub. No.: US 2025/0039638 A1
(43) Pub. Date: Jan. 30, 2025

(54) TIME DIFFERENCE OF ARRIVAL ENHANCEMENTS FOR ULTRA-WIDEBAND

(71) Applicant: QUALCOMM Incorporated, San Diego, CA (US)

(72) Inventors: Varun Amar REDDY, San Diego, CA (US); Alexandros MANOLAKOS, Athens (GR); Pooria PAKROOH, San Marcos, CA (US); Krishna Kiran MUKKAVILLI, San Diego, CA (US)

(21) Appl. No.: 18/716,388

(22) PCT Filed: Feb. 10, 2023
(86) PCT No.: PCT/US2023/012851

§ 371 Date: Jun. 4, 2024

(30) Foreign Application Priority Data
Feb. 23, 2022 (GR) 20220100164

(51) Int. Cl. H04W 4/02; G01S 5/00; G01S 5/06; H04W 74/0816

(52) U.S. Cl. CPC H04W 4/025; G01S 5/0009; G01S 5/06; H04W 74/0816

(57) ABSTRACT

Aspects presented herein may improve the efficiency and accuracy of ranging operations, such as ranging operations based on ultra-wideband or sidelink. In one aspect, a first wireless device receives a response message from at least one second wireless device, the response message including a clock accuracy value of the at least one second wireless device, a location confidence value of the at least one second wireless device, or a combination thereof. The first wireless device establishes a ranging session with the at least one second wireless device based on the clock accuracy value of the at least one second wireless device exceeding a clock accuracy threshold, or the location confidence value of the at least one second wireless device exceeding a location confidence threshold, or both.

### CROSS REFERENCE TO RELATED APPLICATION(S)

This application claims the benefit of and priority to Greek application No. 20220100164, entitled “TIME DIFFERENCE OF ARRIVAL ENHANCEMENTS FOR ULTRA-WIDEBAND” and filed on Feb. 23, 2022, which is expressly incorporated by reference herein in its entirety.

### TECHNICAL FIELD

The present disclosure relates generally to communication systems, and more particularly, to a wireless communication involving positioning based on ultra-wideband (UWB).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus receives a response message from at least one second wireless device, the response message including a clock accuracy value of the at least one second wireless device, a location confidence value of the at least one second wireless device, or a combination thereof. The apparatus establishes a ranging session with the at least one second wireless device based on the clock accuracy value of the at least one second wireless device exceeding a clock accuracy threshold, or the location confidence value of the at least one second wireless device exceeding a location confidence threshold, or both.

In an aspect of the disclosure, a method, a computer-readable medium, and an apparatus are provided. The apparatus transmits a response message to a first wireless device, the response message including a clock accuracy value of the second wireless device, a location confidence value of the second wireless device, or a combination thereof. The apparatus establishes a ranging session with the first wireless device based on the clock accuracy value of the second wireless device exceeding a clock accuracy threshold, the location confidence value of the second wireless device exceeding a location confidence threshold, or both.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5A is a diagram illustrating example roles for an ultra-wideband (UWB) ranging operation in accordance with various aspects of the present disclosure.

FIG. 5B is a diagram illustrating example roles for an UWB ranging operation in accordance with various aspects of the present disclosure.

FIG. 6 is a diagram illustrating an example time-scheduled or contention-free ranging in UWB in accordance with various aspects of the present disclosure.

FIG. 7A is a diagram illustrating an example contention-based ranging in UWB in accordance with various aspects of the present disclosure.

FIG. 7B is a diagram illustrating an example contention-based ranging in UWB in accordance with various aspects of the present disclosure.

FIG. 8 is a diagram illustrating an example hybrid-based ranging in UWB in accordance with various aspects of the present disclosure.

FIG. 9 is a diagram illustrating an example UWB ranging based on downlink-time difference of arrival (DL-TDoA) in accordance with various aspects of the present disclosure.

FIG. 10 is a diagram illustrating an example of associating different clusters with different ranging rounds in accordance with various aspects of the present disclosure.

FIG. 11 is a diagram illustrating an example of enabling an anchor to join a cluster or participate in an UWB ranging session based on demand in accordance with various aspects of the present disclosure.

FIG. 12 is a communication flow illustrating an example of enabling an anchor to join a cluster or participate in an UWB ranging session based on demand in accordance with various aspects of the present disclosure.

FIG. 13 is a communication flow illustrating an example of configuring a ranging session in accordance with various aspects of the present disclosure.

FIG. 14 is a flowchart of a method of wireless communication.

FIG. 15 is a flowchart of a method of wireless communication.

FIG. 16 is a diagram illustrating an example of a hardware implementation for an example apparatus and/or network entity.

FIG. 17 is a flowchart of a method of wireless communication.

FIG. 18 is a flowchart of a method of wireless communication.

FIG. 19 is a diagram illustrating an example of a hardware implementation for an example apparatus and/or network entity.

### DETAILED DESCRIPTION

Aspects presented herein may improve/enhance an ultra-wideband (UWB) ranging session, such as in terms of anchor capability/performance, cluster formation and forming subsets of clusters, seamless association of a new anchor with a cluster, and flexibility in the selection of anchors based on relevant criteria. Aspects presented herein may also extended to sidelink (SL) out-of-coverage scenarios. In one aspect of the present disclosure, an anchor (e.g., an initiator anchor, a responder anchor, etc.) may be configured to include specified information elements in its a downlink-time difference of arrival (DL-TDoA) message (DTM) message(s) that may be used for assisting a cluster selection process. For example, each anchor in a set of anchors may provide its clock stability/accuracy and/or ground truth accuracy in its DTM messages(s). Then, an anchor forming a cluster may determine/categorize which anchors in the set of anchor to use/include for an UWB session based on their clock stabilities/accuracies and/or ground truth accuracies, such that more accurate/reliable UWB ranging/positioning may be achieved.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

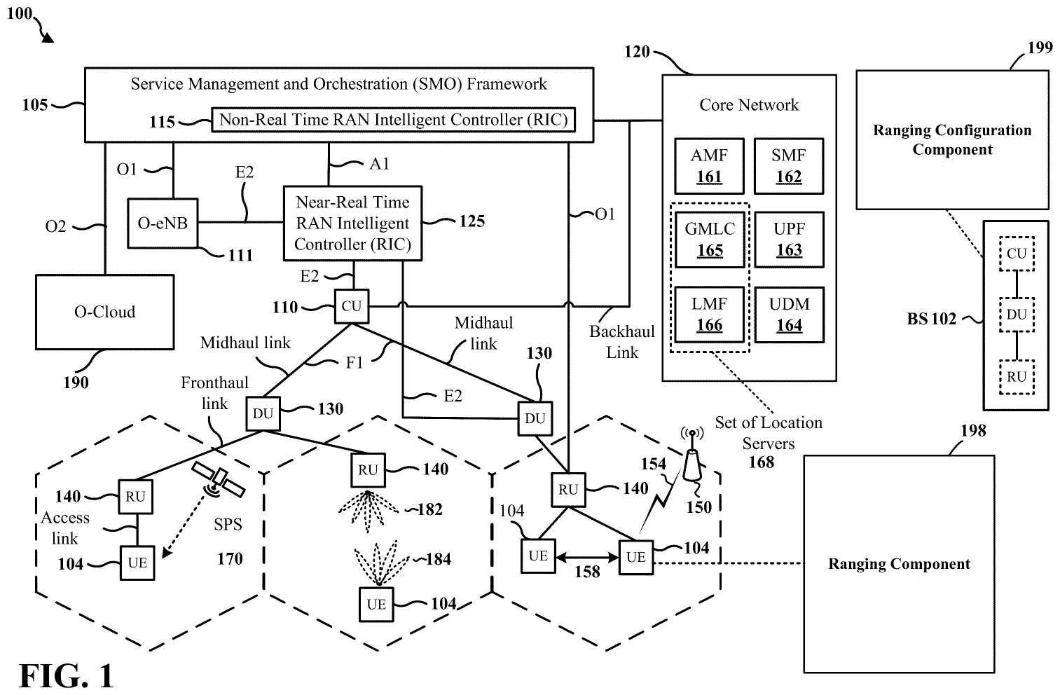

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a ranging component 198 that may be configured to receive a response message from at least one second wireless device, the response message including a clock accuracy value of the at least one second wireless device, a location confidence value of the at least one second wireless device, or a combination thereof; and establish a ranging session with the at least one second wireless device based on the clock accuracy value of the at least one second wireless device exceeding a clock accuracy threshold, or the location confidence value of the at least one second wireless device exceeding a location confidence threshold, or both.

In certain aspects, the ranging component 198 that may be configured to transmit a response message to a first wireless device, the response message including a clock accuracy value of the second wireless device, a location confidence value of the second wireless device, or a combination thereof; and establish a ranging session with the first wireless device based on the clock accuracy value of the second wireless device exceeding a clock accuracy threshold, the location confidence value of the second wireless device exceeding a location confidence threshold, or both.

In certain aspects, the base station 102 may have a ranging configuration component 199 that may be configured to configure ranging parameters for the UEs.

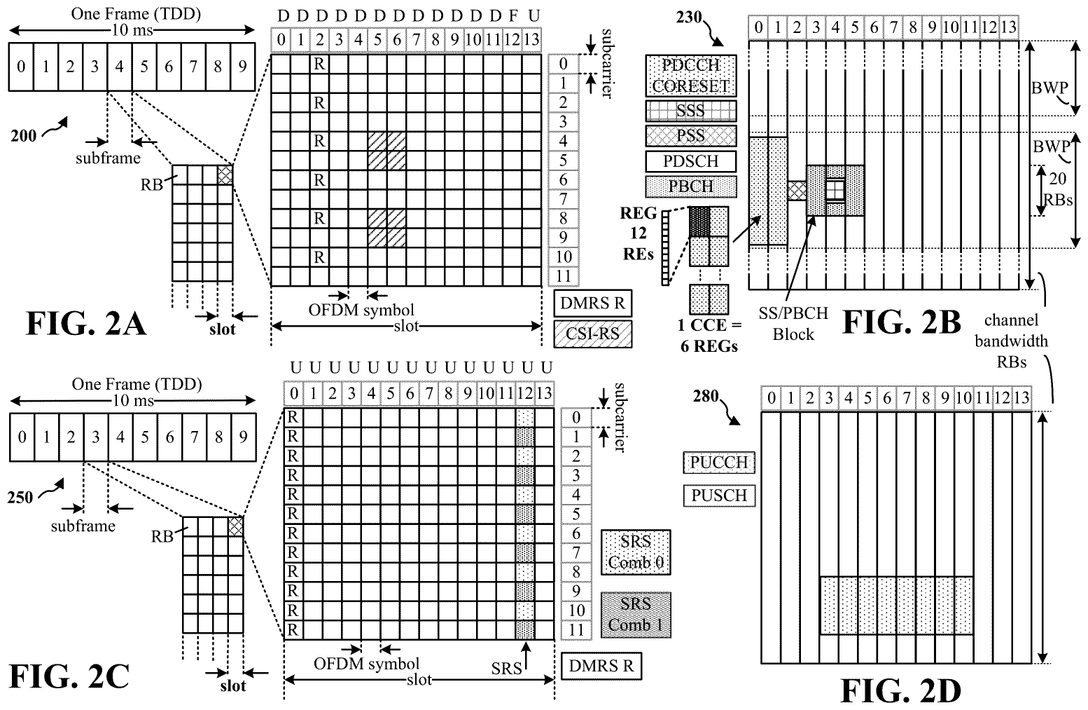

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

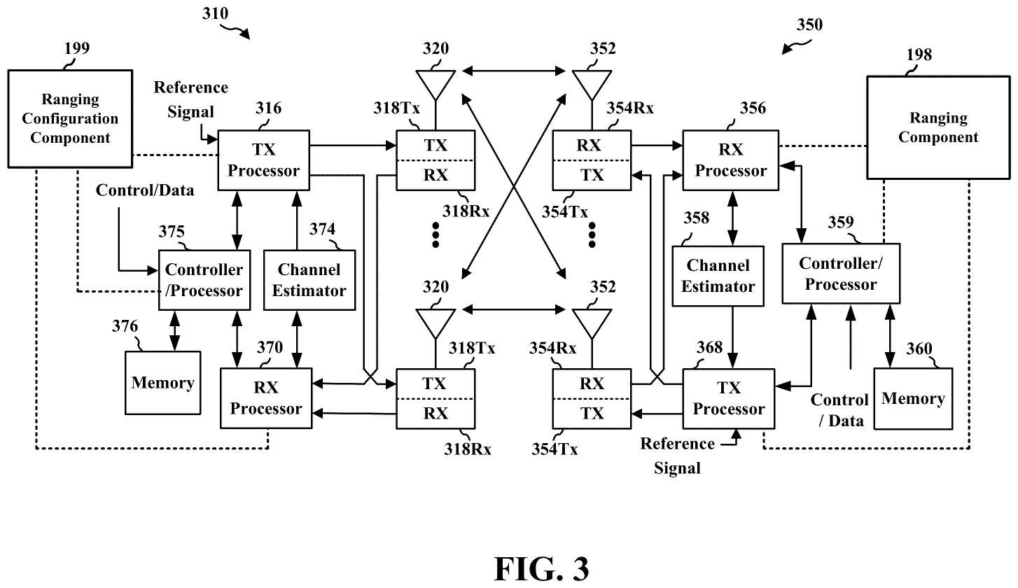

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency-domain, and then combined together using an Inverse Fast Fourier Transform (IFFT) to produce a physical channel carrying a time-domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency-domain using a Fast Fourier Transform (FFT). The frequency-domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the ranging component 198 of FIG. 1.

At least one of the TX processor 316, the RX processor 370, and the controller/processor 375 may be configured to perform aspects in connection with the ranging configuration component 199 of FIG. 1.

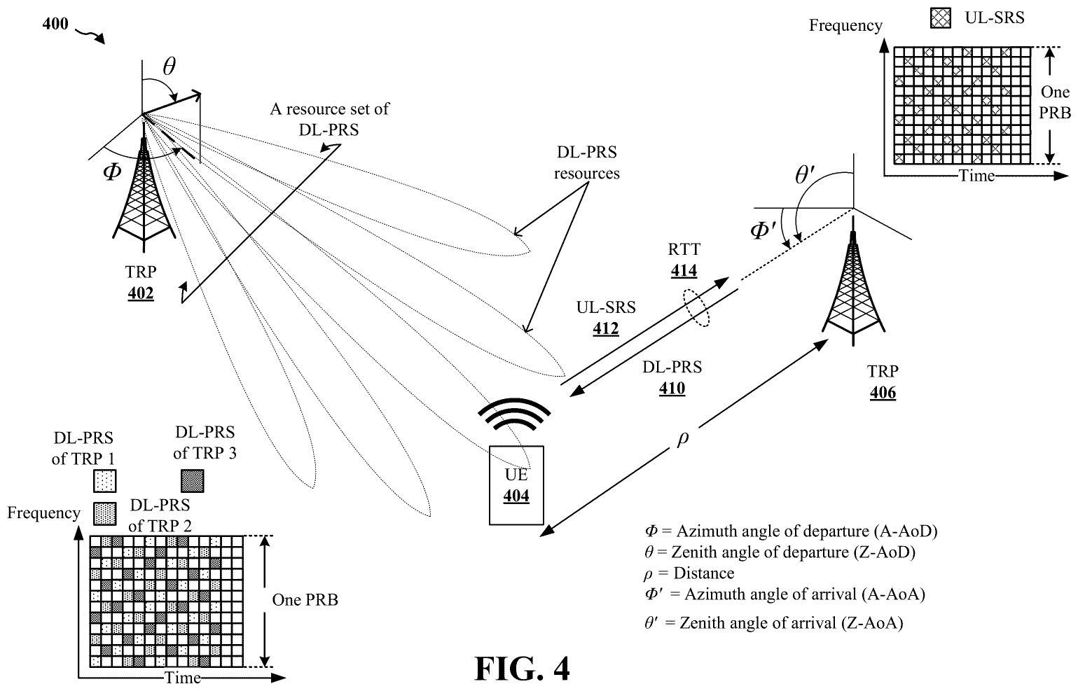

FIG. 4 is a diagram 400 illustrating an example of a UE positioning based on reference signal measurements (which may also be referred to as “network-based positioning”) in accordance with various aspects of the present disclosure. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information. For example, some UE positioning mechanisms may be radio access technology (RAT)-dependent (e.g., the positioning of a UE is based on a RAT), such as the downlink positioning (e.g., measuring of observed time difference of arrival (OTDOA), the uplink positioning (e.g., measuring of uplink time difference of arrival (UTDOA), and/or the combined DL and UL based positioning (e.g., measuring of RTT with respect to neighboring cells), etc. Some wireless communications systems may also support Enhanced Cell-ID (E-CID) positioning procedures that are based on radio resource management (RRM) measurements. On the other hand, some UE positioning mechanisms may be RAT-independent (e.g., the positioning of a UE does not rely on a RAT), such as the enhanced GNSS, and/or positioning technologies based on WLAN, Bluetooth, Terrestrial Beason System (TBS), and/or sensor based (e.g., barometric sensor, motion sensor), etc. Some UE positioning mechanisms may be based on a hybrid model, where multiple methods for positioning are used, which may include both RAT-dependent positioning technology and RAT-independent positioning technology (e.g., a GNSS with OTDOA hybrid positioning).

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

Positioning based on measurement of time of arrival (ToA) and/or time difference of arrival (TDoA) may sometimes be referred to as ranged-based positioning, where the position of a wireless device may be determined based on measurements of distances between the wireless device and other wireless devices. For example, in range-based positioning, distances between wireless devices with a known location may be used for estimating the position of another wireless device without a known location based on a trilateration (or multilateration) process. In some examples, ranged-based positioning may be based on ultra-wideband (UWB) communications, where the UWB communications may include a radio signal with an instantaneous bandwidth of greater than 500 MHz or a fractional occupied bandwidth (Bf) greater than 0.2. For purposes of the present disclosure, a range-based positioning based on UWB may be referred to as UWB ranging, UWB positioning, an UWB ranging session, an UWB session, and/or an UWB ranging operation, etc. In one example, UWB ranging may refer to a device that is equipped with a UWB radio such as a smartphone, wristband, or smart key comes into range of another UWB device, and the devices start ranging. The ranging may be done by performing Time of Flight (ToF) measurements between the devices. The ToF may be calculated by measuring the roundtrip time of challenge/response packets. Depending on the type of the application (e.g. in case of asset tracking, device localization), either the mobile or the fixed UWB device may calculate the precise location of the device. In the case where the device is running an indoor navigation service, it may be specified to know its relative location to the fixed UWB anchors and calculate its position on the area map. As such, a UWB ranging session or a UWB session may refer to an instance, an occurrence, or a period of time where a device is configured to perform UWB ranging. In some examples, UWB may use very large channel bandwidth (500 MHZ) with short pulses of about 2 nanoseconds each (e.g., this may help achieve centimeter accuracy). The UWB positioning process may happen in an instant, so the mobile device's movements can be tracked very accurately in real time. On the other hand, sidelink ranging session may refer to a ranging operation based on sidelink.

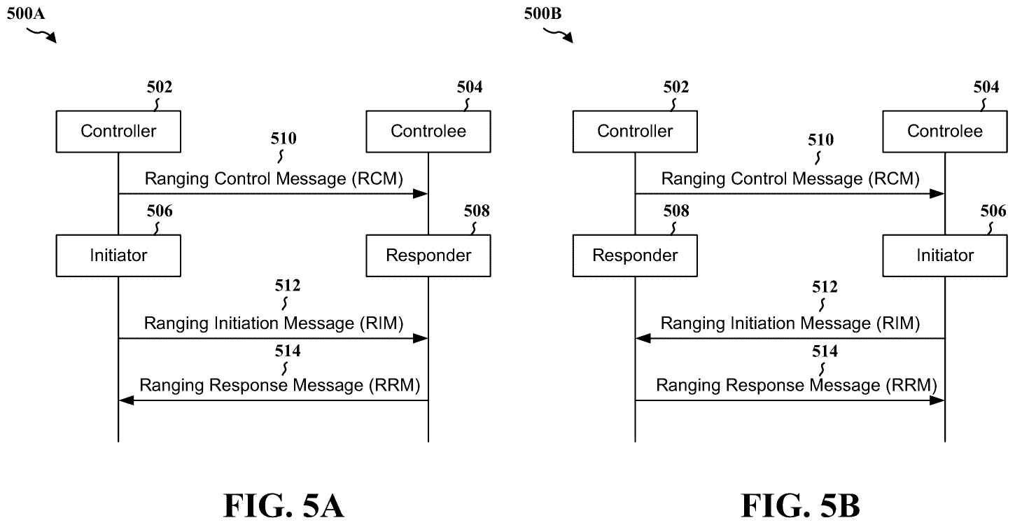

FIGS. 5A and 5B are diagrams 500A and 500B, respectively, illustrating example roles (e.g., logical/network entities) in an UWB ranging operation in accordance with various aspects of the present disclosure. In one example, an UWB ranging operation may be performed by a set of enhanced ranging devices (ERDEVs) that is capable of communicating with each other via an UWB (e.g., transmitting/receiving UWB signals or waveforms) and also via non-UWB (which may be referred to as an out-of-band (OOB) communication, e.g., Bluetooth communication, Wi-Fi communication, etc.). In some examples, the ERDEVs may be a set of base stations, components of a base stations, a set of UEs, components of a UE, or a combination thereof.

Referring to the diagrams 500A and 500B, an UWB ranging operation may include multiple entities (or ERDEVs), such as a controller 502, a controlee 504, an initiator 506, and a responder 508. The controller 502 and the controlee 504 may be logical entities that are at a higher layer of a protocol stack, such as an application that is responsible for transmitting control messages (e.g., an application running on a device). On the other hand, the initiator 506 and the responder 508 may be operating at a physical (PHY) layer or a medium access control (MAC) layer, where signals may be exchanged between the initiator 506 and the responder 508 over the air based on UWB.

For example, as shown at 510, the controller 502 may be an ERDEV that controls an UWB ranging operation and defines the UWB ranging operation parameters for one or more controlees (e.g., the controlee 504) by sending a ranging control message (RCM) to the one or more controlees. The controlee 504 may be an ERDEV that utilizes the UWB ranging operation parameters received from the controller 502 in the RCM.

As shown at 512, the initiator 506 may be an ERDEV that follows the RCM and initiates a ranging message exchange by sending a first ranging message of the exchange (e.g., a ranging initiation message (RIM)) to one or more responders (e.g., the responder 508). Either a controller or a controlee may be an initiator. For example, as shown by the diagram 500A of FIG. 5A, the controller 502 may be the initiator 506, and as shown by the diagram 500B of FIG. 5B, the controlee 504 may be the initiator 506.

As shown at 514, the responder 508 may be an ERDEV that responds to the RIM received from the initiator 506. For example, in response to the RIM, the responder 508 may transmit a ranging response message (RRM) to the initiator 506. In one example, based on the RRM, the initiator 506 may determine a distance between the initiator 506 and the responder 508, such as based on the time of flight (ToF) of the RRM. For purposes of the present disclosure, a “ranging message” may refer to any types of messages that is transmitted during a ranging session, such as an UWB ranging session. The RRM may refer to a message that is transmitted in response to an RIM.

In some implementations, the transmission of the RCM at 510 may be based on OOB communications (e.g., non-UWB communications, such as based on Bluetooth communications, Wi-Fi communications, or other types of RF communications), whereas the transmission of the ranging messages (e.g., the RIM and/or the RRM, etc.) at 512 and 514 may be based on UWB (e.g., which may also be referred to as “in-band” communications). For purposes of the present disclosure, an UWB session may refer to a ranging session that is based on UWB. While aspects presented herein may use UWB as examples, aspects presented herein may also apply to sidelink or other types of ranging operations, which may also be considered as within the scope of the present disclosure.

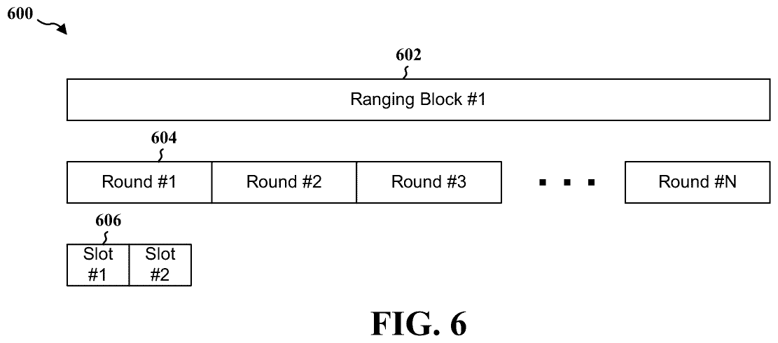

FIG. 6 is a diagram 600 illustrating an example time-scheduled or contention-free ranging in UWB in accordance with various aspects of the present disclosure. In one example, an UWB session between two devices may include consecutive ranging blocks 602. Each ranging block 602 may include multiple ranging rounds 604, and each ranging round 604 may in turn have several ranging slots 606. Within a ranging block 602, a responder (e.g., the responder 508) may transmit a message within a single ranging round 604. A ranging round index may be either statically configured by a controller (e.g., the controller 502) or selected based on a hopping pattern. The ranging slots 606 within a chosen ranging round 604 may be used sequentially to perform either single side-two way ranging (SS-TWR) or double side-two way ranging (DS-TWR). In some examples, multiple UWB sessions may be time-multiplexed (e.g., performed at different times) to prevent interference with one and another.

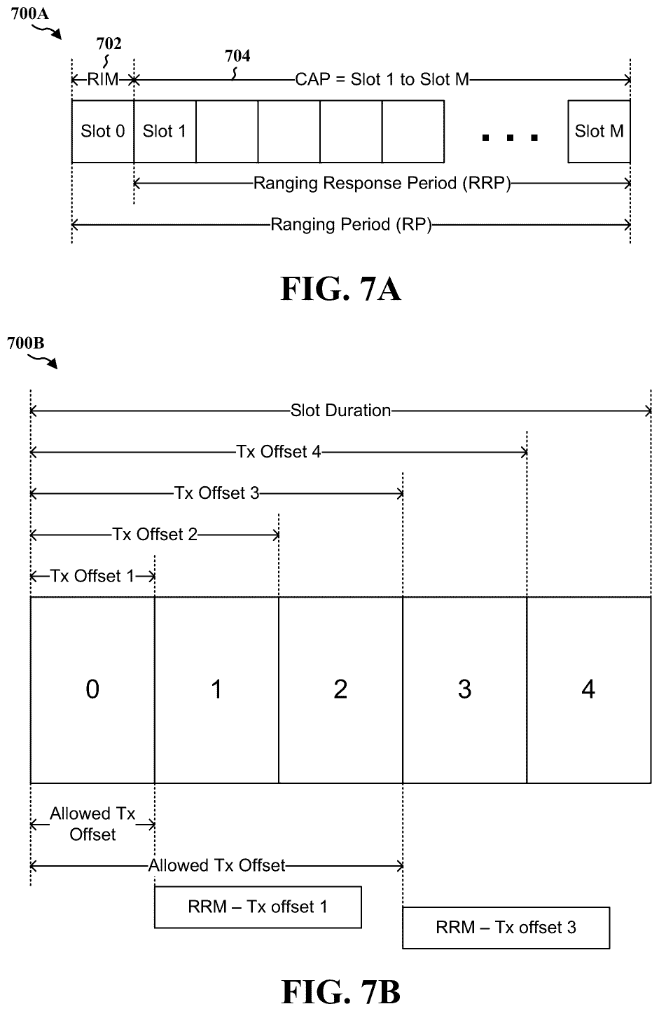

FIGS. 7A and 7B are diagrams 700A and 700B, respectively, illustrating an example contention-based ranging in UWB in accordance with various aspects of the present disclosure. In one example, a controller (e.g., the controller 502) may initiate a contention-based ranging when the controller does not know about the device(s) that are going to participate in an UWB session. In some implementations, the controller may be configured to assume the role of the initiator (e.g., the initiator 506), and the controlees (e.g., the controlee 504) may be configured to assume the role of the responders (e.g., the responder 508), such as shown by FIG. 5A.

As shown at 702 of FIG. 7A, to initiate a contention-based ranging, a controller (e.g., the controller 502) may advertise (e.g., transmitting/broadcasting) a contention-access period (CAP) via a ranging initiation message (RIM) to one or more devices. For purposes of the present disclosure, the term CAP may refer to a period of time during which a wireless device (e.g., a UE, a tag, a responder anchor) may send a message to or access a wireless medium using slotted carrier-sense multiple access with collision avoidance (CSMA-CA). On the other hand, the term CFP may refer to a period of time during which access to a wireless medium (e.g., an anchor) is free of contention.

As shown at 704, the CAP may include a portion of ranging slots within a ranging round (e.g., from slot 1 to slot M). A device that is configured to take part (e.g., participate) in the UWB session (and is not known by the controller) may randomly select a ranging slot from the portion of ranging slots (e.g., from slot 1 to slot M) and transmit a ranging response message (RRM) to the controller using the selected ranging slot, such as described in connection with FIG. 6. In some examples, as shown by the diagram 700B, within a ranging slot, a device that is taking part in the UWB session may also transmit an RRM after a random time offset. In other words, the device may not be specified to transmit the RRM from the beginning of the slot. In some examples, the allowable values for such a time offset may be contained within the control message from the controller.

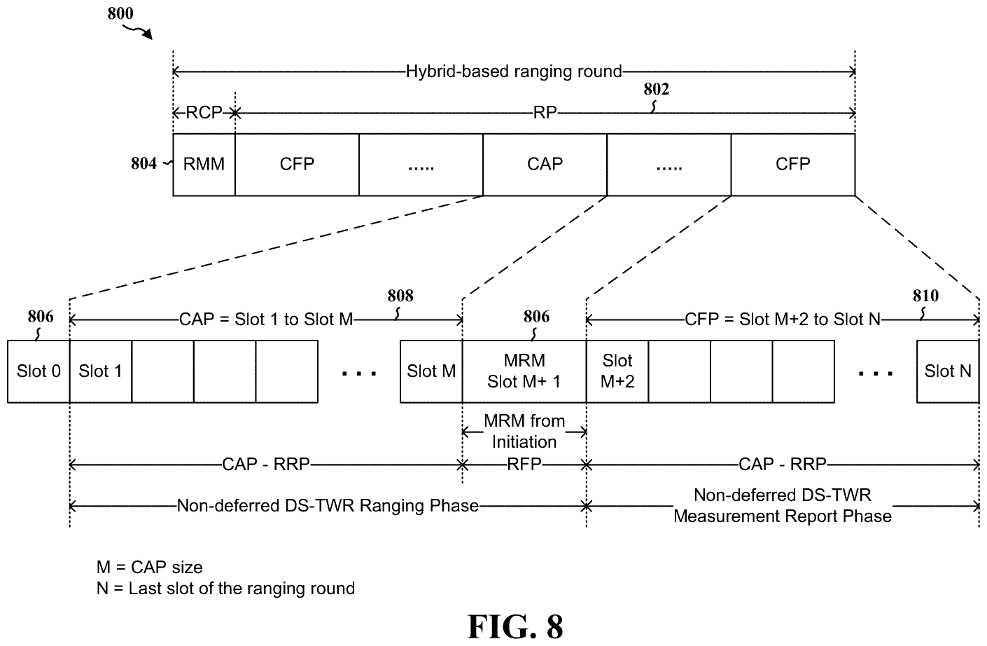

FIG. 8 is a diagram 800 illustrating an example hybrid-based ranging in UWB in accordance with various aspects of the present disclosure. In some examples, an UWB session may be configured with a hybrid-based ranging mode that allows a combination of time-scheduled (e.g., contention free) ranging and contention-based ranging in the same UWB Session.

For example, as shown at 802, a hybrid-based ranging round may include one or more CAPs and one or more contention free periods (CFPs). In certain scenarios, there may be a set of known controlees and a set of unknown controlees. In such scenarios, it may be beneficial for a controller to perform an UWB session with known controlees based on time-scheduled (e.g., contention free) mode, and perform the UWB session with unknown controlees based on the contention-based mode. For example, as shown at 808, a device that is not known to the controller that initiates the UWB session may randomly select a ranging slot in a CAP (e.g., from slot 1 to slot M) to transmit an RRM, such as described in connection with FIGS. 7A and 7B. On the other hand, as shown at 810, a device that is known to the controller may randomly select a ranging slot or use a specified/configured slot in a CFP (e.g., from slot M+2 to slot N) to transmit an RRM. As shown at 804, the first slot of the hybrid-based ranging round may be reserved for a control message that determines or indicates the start/end of each of the phases (e.g., a CFP phase or a CAP phase, etc.). As shown at 806, the first slot of each of the CAP and CFP phases may be reserved for control messages that determine the scheduling of the slots within the respective phase. In some examples, the last slot of each of the CAP and CFP phases may be reserved for a final message.

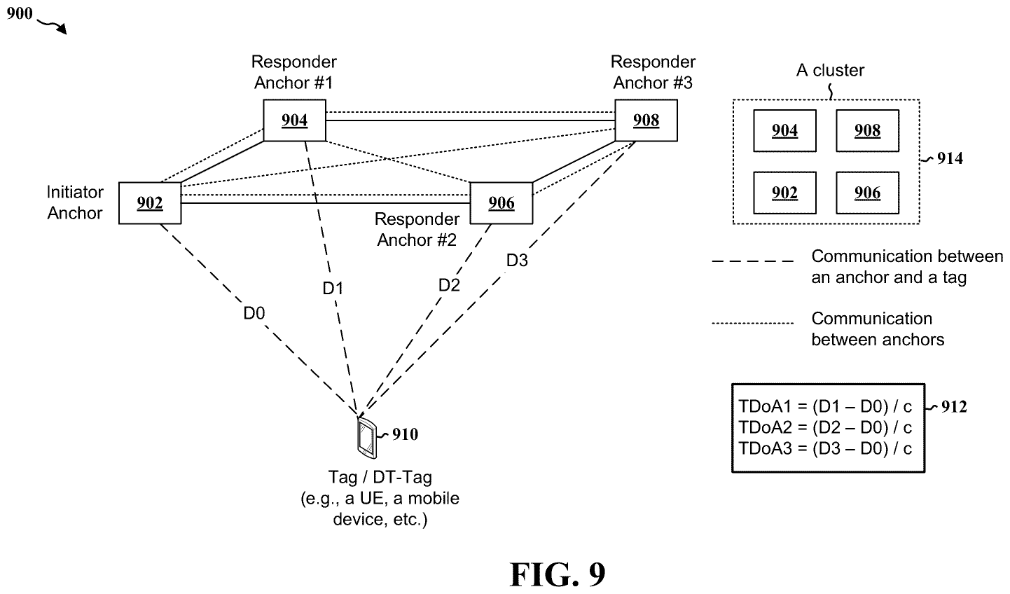

FIG. 9 is a diagram 900 illustrating an example UWB ranging based on downlink-time difference of arrival (DL-TDoA) in accordance with various aspects of the present disclosure. In one example, a DL-TDoA message (DTM) transmitted from a transmitting device (e.g., a fine ranging (FiRa) device, which may be an initiator or a responder) may be used by one or more receiving devices for performing localization or positioning. In some examples, this transmitting device may also be referred to as an anchor (e.g., an initiator anchor may be referred to as an initiator anchor, and a responder may be referred to as a responder anchor, etc.), and a receiving device may also be referred to as a tag, a DL-TDoA tag (DT-Tag), a mobile device, and/or a UE. In general, an UWB ranging operation (e.g., an UWB session) may include one initiator anchor and multiple responder anchors, where a tag may listen and receive ranging messages (e.g., DTMs) transmitted from the initiator anchor and the responder anchors to determine its location based on the TDoA of ranging messages received.

For example, as shown by the diagram 900, an UWB ranging operation may include an initiator anchor 902, a first responder anchor 904, a second responder anchor 906, and a third responder anchor 908 (collectively as “DL-TDoA anchors”) that are configured to transmit/broadcast DTMs. A tag 910 may receive DTMs transmitted by these DL-TDoA anchors, and measure the reception times of every DTM that the tag 910 receives. Then, the tag 910 may utilize the reception timestamp along with obtained coordinates of DL-TDoA anchors to estimate its position. For example, as shown at 912, the tag 910 may calculate the TDoA for DTMs received between the initiator anchor 902 and other responder anchors 904, 906, and 908. Then, the tag 910 may estimate its position based on a trilateration (or multilateration) process. In some examples, the DTMs may also be used by anchors for performing synchronization between them. While DTMs may be exchanged between anchors, a tag may be configured to passively listen and receive DTMs (e.g., without transmitting messages to the anchors).

In one example, as shown at 914, a set of anchors that transmits DTMs or exchange DTMs with each other to provide a localization service to tags may be referred to as a cluster or a cluster of anchors. As such, a cluster may include one initiator anchor and one or more responder anchors. For example, the initiator anchor 902, the first responder anchor 904, the second responder anchor 906, and the third responder anchor 908 may be a cluster or part of a cluster.

To create or establish a cluster, an anchor (e.g., a Bluetooth advertiser) may broadcast configuration messages (e.g., OOB configuration messages, RCMs, etc.) associated with UWB ranging to other anchors within a coverage area. For example, the initiator anchor 902 may create a cluster by broadcasting configuration messages to the first responder anchor 904, the second responder anchor 906, and the third responder anchor 908 based on OOB communications (e.g., non-UWB communications, Bluetooth communications, etc.). After receiving the configuration messages, the first responder anchor 904, the second responder anchor 906, and the third responder anchor 908 may apply UWB ranging related parameters in the configuration messages and join the cluster created by the initiator anchor 902. Then, the cluster may provide UWB ranging for one or more tags, such as the tag 910.

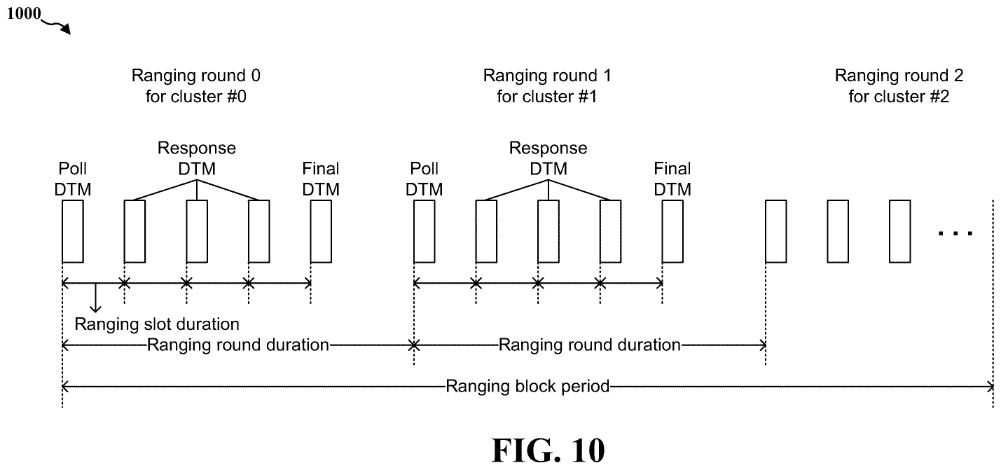

In some examples, as shown by a diagram 1000 of FIG. 10, when there is a plurality of clusters (e.g., clusters 0, 1, 2 . . . ), different clusters may be configured to perform UWB ranging in different time periods (e.g., ranging rounds) to avoid interference between clusters. For example, a first cluster (e.g., cluster #0) may be configured to perform an UWB ranging operation on a first ranging round, and a second cluster (e.g., cluster #1) may be configured to perform an UWB ranging operation on a second ranging round that does overlap with the first ranging round in time.

Aspects presented herein may improve/enhance an UWB ranging session, such as in terms of anchor capability/performance, cluster formation and forming subsets of clusters, seamless association of a new anchor with a cluster, and flexibility in the selection of anchors based on relevant criteria. Aspects presented herein may also extended to sidelink (SL) out-of-coverage scenarios. In one aspect of the present disclosure, an anchor (e.g., an initiator anchor, a responder anchor, etc.) may be configured to include specified information elements in its DTM message(s) that may be used for assisting a cluster selection process. For example, each anchor in a set of anchors may provide its clock stability/accuracy and/or ground truth accuracy in its DTM messages(s). Then, an anchor forming a cluster may determine/categorize which anchors in the set of anchor to use/include for an UWB session based on their clock stabilities/accuracies and/or ground truth accuracies, such that more accurate/reliable UWB ranging/positioning may be achieved.

For example, an anchor (e.g., a responder, a responder anchor, etc.) may transmit a DTM message that includes a one-bit field indicating whether the clock source of the anchor is stable to within a defined part per million (ppm) (e.g., within +/−25 ppm, +/−50 ppm, etc.). For example, bit-1 may indicate the clock source of the anchor is stable to within the defined ppm, whereas bit-0 may indicate the clock source of the anchor is not stable to within the defined ppm, etc. Then, an anchor (e.g., an initiator, an initiator anchor, etc.) may form a cluster (e.g., select a set of responder anchors) for an UWB session based on the indication. For example, if the UWB session specifies high positioning accuracy, an initiator anchor may select responder anchors with clock sources stable to within the defined ppm.

In some scenarios, such one-bit indication may not be sufficient or accurate enough for certain positioning operations. For example, for positioning based on TDoA, it may be more suitable or beneficial to determine the exact accuracy of an anchor's clock. As such, in another aspect of the present disclosure, the DTM message may include a clock stability/accuracy value or field associated with the anchor that indicates/specifies the exact ppm associated with the anchor. For example, a clock stability/accuracy field ranges in size from 6 to 8 bits may be used by an anchor to indicate its clock stability accuracy. Similarly, an initiator anchor may form a cluster for an UWB session based on the clock stability/accuracy of the responder anchors in the cluster.

In another example, an anchor (e.g., a responder, a responder anchor, etc.) may transmit a DTM message that includes its location, such as the latitude/longitude coordinates or the x/y/z coordinates of the anchor (which may also be referred to as the “ground truth” location of the anchor). In addition, the DTM message may further include a field that specifies/indicates a confidence metric associated with the ground truth location provided by the anchor. For example, in some scenarios, while an anchor may estimate its location, the accuracy of the estimated location may be low. Thus, by enabling an anchor to also indicate a confidence level associated with its provided location, an anchor forming a cluster for an UWB session may further take the confidence level associated with each anchor into consideration. For example, if an UWB session specifies high positioning accuracy, an initiator anchor may select responder anchors that provide their ground truth locations with high confidence levels or with a confidence level above a confidence threshold, etc.

In one example, similar to the indication of the clock stability/accuracy, the confidence level may be indicated using a one-bit field. For example, bit-1 may be used for indicating that the confidence level for the ground truth location provided by an anchor is above a defined confidence threshold, and bit-0 may be used for indicating that the confidence level is not above the defined confidence threshold. Similarly, as such one-bit indication may not be sufficient or accurate enough for certain positioning operations, in some scenarios, it may be more suitable or beneficial for an anchor to indicate more precisely how confident the anchor is about its location. For example, a ground truth accuracy value or field associated with the anchor may be included in the DTM message that provides a confidence metric of the ground truth (e.g., the confidence level). In one example, the ground truth accuracy may be configured to be expressed in terms of root-mean-square error (RMSE) error, which may specify approximately 8 bits.

Based at least in part on these specified fields (e.g., the clock stability/accuracy field, the ground truth accuracy field, etc.), a controller or an initiator anchor may make various decisions to improve the accuracy and/or reliability of an UWB session. For example, in one aspect of the present disclosure, a controller or an initiator anchor may modify a cluster formation process based on the clock stabilities/accuracies and/or the ground truth accuracy associated with anchors in the cluster. Instead of simply admitting new anchor(s) (e.g., responder anchors) into a cluster regardless of their performance metrics, a controller or an initiator anchor may be configured to just allow responder anchors with a minimum clock source accuracy and/or a minimum ground truth accuracy to join the cluster. In other words, just responder anchors that meet the minimum clock source accuracy threshold and/or the minimum ground truth accuracy threshold may join the cluster for the UWB session.

In some examples, some of the anchors may have access to another technology/entity with a superior clock, such as an NR-base station (or network entity) or an accurate GNSS/GPS node. Thus, a controller or an initiator anchor may also be configured to form a cluster using anchors that have access to a technology with a superior clock (e.g., a clock with accuracy/reliability above an accuracy/reliability threshold), such as when an UWB ranging session specifies a high positioning accuracy. As such, for a given cluster or an UWB ranging session, an initiator anchor may poll just a subset of responder anchors based on their clock stabilities/accuracies and/or ground truth accuracies. Such configuration may provide an adaptive positioning performance based on a desired/specified quality of service (QOS) for the DL-TDoA (DT)-tags/mobile users.

In another aspect of the present disclosure, an anchor or a set of anchors (e.g., responder anchor(s)) may join a cluster or participate in an UWB ranging session based on demand (which may be referred to as ‘on-demand’ anchor(s)). In some UWB ranging operations, an anchor (e.g., a responder anchor) may be configured to join a cluster based on OOB communications (e.g., Bluetooth), where an advertiser (e.g., an initiator anchor) may broadcast configuration messages to multiple anchors, and a new anchor may join the cluster through OOB setup (e.g., after receiving the configuration message). However, instead of allowing new anchors to join a cluster “on-the-go” (e.g., based on just receiving the configuration message), aspects presented herein may enable an initiator anchor to advertise a contention-access period (CAP) during which tags or other anchors (e.g., devices that are capable of determining/knowing their location and want to provide services as anchors) may transmit a response DTM message to join the cluster.

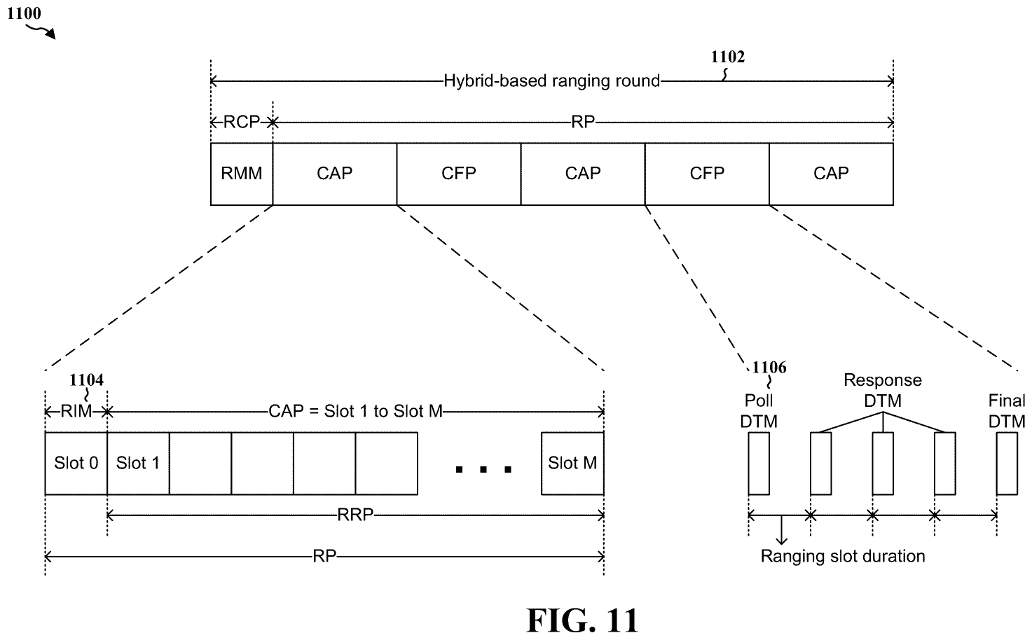

FIG. 11 is a diagram 1100 illustrating an example of enabling an anchor to join a cluster or participate in an UWB ranging session based on demand in accordance with various aspects of the present disclosure. In one example, as shown at 1102, an initiator anchor may initiate a hybrid-based ranging round, such as described in connection with FIG. 8, where the hybrid-based ranging round may include one or more CAPs and one or more CFPs. In addition, different CAPs and/or CFPs may be associated with different quality-of-service (QOS) levels. For example, the first CAP and the first CFP may be associated with a high-accuracy ranging session (e.g., a first QoS level), and the subsequent CAP and CFP (e.g., the second CAP and the second CFP) may be associated with a lower-accuracy ranging session (e.g., a second QoS level). Then, a tag (e.g., the tag 910, a UE, etc.) and/or an anchor may join an UWB session or a cluster by choosing a corresponding CAP/CFP based on its specification. For example, a tag/anchor that is configured to perform/join a high-accuracy ranging session may choose a CAP/CFP that is associated with the high-accuracy ranging session. On the other hand, a tag/anchor that does not specify a high-accuracy ranging session may choose a CAP/CFP that is associated with a lower-accuracy ranging session, etc.

As shown at 1104, during a CAP, the initiator anchor may transmit a poll-DTM message (e.g., via a RIM) to a set of anchors during a first slot (e.g., slot 0) of the CAP. Then, a new/potential anchor (e.g., a responder anchor, which may also be referred to as a DL-TDoA (DT)-anchor) that is configured to join the cluster (or the UWB session) may hop onto one of the CAP slots (e.g., from slot 1 to slot M) and transmit a DTM response message to the initiator anchor. The new/potential anchor may choose a CAP slot randomly. In some examples, the last slot of the CAP (e.g., slot M) may be reserved for a final DTM message. Such configuration may enable new/potential anchors to join a cluster during the same round without having to wait for subsequent round(s) (by performing OOB setup), thereby reducing the latency associated with forming/modifying a cluster. Similarly, as shown at 1106, during a CFP, the initiator anchor may transmit a poll-DTM message (e.g., via a RIM) to a set of anchors during a first slot of the CFP. Then, an anchor may join the UWB session by transmitting a DTM response message to the initiator anchor using one of the CFP slots. The last slot of the CFP may also be reserved for a final DTM message.

There may be multiple implementations for the poll-DTM message. In one implementation, each ranging round may include a single CAP and a single CFP that are dedicated to a single cluster. In another implementation, different clusters may have their own CAP and/or CFP, which may be within the same ranging round.

In another aspect of the present disclosure, as described above, an initiator anchor (e.g., the initiator anchor 902) may also advertise its specifications for one or more UWB sessions in a poll-DTM message, where the specifications may include a specified clock stability/accuracy and/or a specified ground truth accuracy (e.g., an overall QoS). Then, a potential anchor (e.g., a responder anchor) may take part in a corresponding CAP/CFP if the potential anchor is capable of meeting these specifications. Similarly, multiple (CAP+CFP) phases in a ranging round may be categorized according to the specified QoS (e.g., position accuracy). For instance, a tag specifying a certain QoS level may take part in a corresponding (CAP+CFP) phase that is associated with such QoS level. In some scenarios, this may provide opportunities for power-saving at the tags. For example, a tag may operate in a sleep mode for the portion of the ranging round that does not provide the QoS that is specified by the tag.

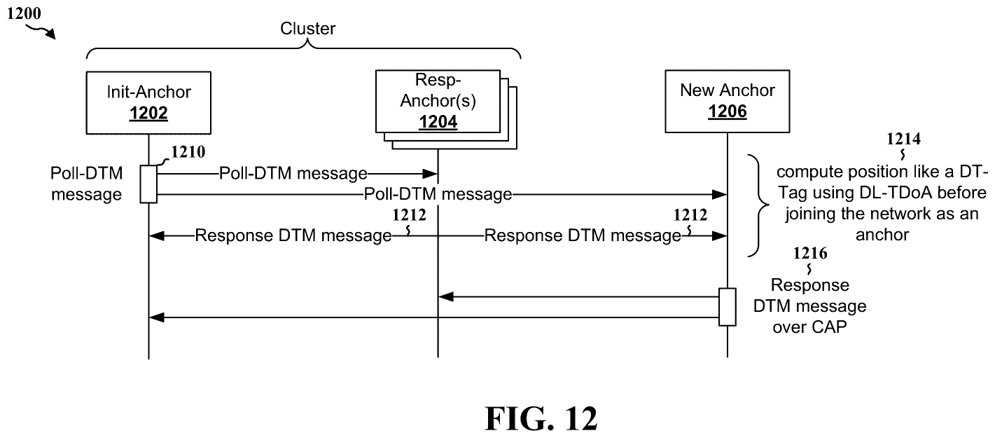

FIG. 12 is a communication flow 1200 illustrating an example of enabling an anchor to join a cluster or participate in an UWB ranging session based on demand in accordance with various aspects of the present disclosure. In some examples, a new/potential anchor (e.g., a responder anchor) may be configured/specified to determine its position before the new/potential anchor is able to join a cluster.

For example, as shown at 1210, an initiator anchor 1202 may transmit a poll-DTM message to a plurality of devices, which may be received by one or more responder anchors 1204 and a new anchor 1206. The initiator anchor 1202 and the one or more responder anchor(s) 1204 may belong to a cluster that is associated with one or more UWB sessions.

As shown at 1212, in response to the poll-DTM message, the one or more responder anchors 1204 may transmit a response DTM message, such as described in connection with FIG. 9. The response DTM message may be received by both the initiator anchor 1202 and the new anchor 1206.

As shown at 1214, based on the poll-DTM message received from the initiator anchor 1202 and the response DTM message received from the one or more responder anchors 1204, the new anchor 1206 may compute its position based on DL-TDoA (e.g., similar to a tag). In other words, the new anchor 1206 may passively listen to the exchange of DTM messages between the initiator anchor 1202 and the one or more responder anchors 1204, which may be either CAP or CFP. The new anchor 1206 may compute its position based on these DTM messages.

Then, as shown at 1216, after the new anchor 1206 computed/estimated its position, the new anchor 1206 may join the cluster in a next occurring CAP/CFP and serve as an anchor.

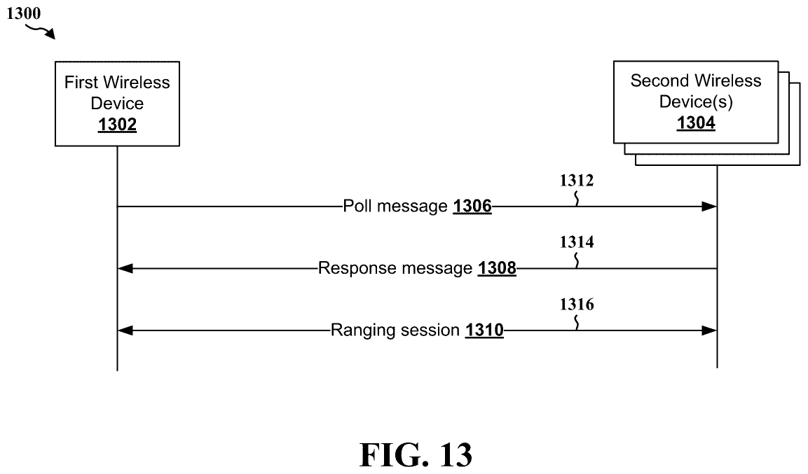

FIG. 13 is a communication flow 1300 illustrating an example of configuring (e.g., setting up) a ranging session (e.g., an UWB session) in accordance with various aspects of the present disclosure. The numberings associated with the communication flow 1300 do not specify a particular temporal order and are merely used as references for the communication flow 1300.

At 1312, a first wireless device 1302 (e.g., the initiator 506, the initiator anchor 902, etc.) may initiate at least one ranging round (e.g., an UWB ranging session, a sidelink ranging session, etc.) by transmitting a poll message 1306 (e.g., a DL-TDoA poll message, a poll-DTM message, a first sidelink message, etc.) to at least one second wireless device 1304 (e.g., the responder 508, the responder anchor 904, 906, 908, etc.). In one example, the first wireless device 1302 may be a controller anchor, a first sidelink device, a first network entity (e.g., a base station/TRP), etc., and the at least one second wireless device 1304 may be a responder anchor, a second sidelink device, a second network entity, etc., such as described in connection with FIGS. 5A, 5B, 9 and 12.

In some examples, as described in connection with FIG. 11, the poll message 1306 may specify clock stability/accuracy and/or ground truth accuracy (e.g., an overall QoS) for the at least one ranging round. For example, a dedicated field in the poll message 1306 may indicate a clock accuracy threshold and/or a location confidence threshold specified for the at least one ranging round.

At 1314, in response to the poll message 1306, the at least one second wireless device 1304 may transmit a response message 1308 (e.g., a DL-TDoA response message, a response DTM message, a second sidelink message, etc.) to the first wireless device 1302. In one example, based on the clock accuracy threshold and/or the location confidence threshold indicated by the first wireless device 1302, the response message 1308 may include a clock accuracy value and/or a location confidence value of the at least one second wireless device 1304.

At 1316, based on the exchanging of the poll message 1306 and the response message 1308, the first wireless device 1302 may establish the at least one ranging session with the at least one second wireless device 1304, such as described in connection with FIG. 9. In some examples, the first wireless device 1302 may establish the at least one ranging session with the at least one second wireless device 1304 based on the clock accuracy value of the at least one second wireless device 1304 exceeding the indicated clock accuracy threshold, and/or based on the location confidence value of the at least one second wireless device 1304 exceeding the indicated location confidence threshold.

In one example, the first wireless device 1302 may transmit an indication of a CAP to the at least one second wireless device 1304 (e.g., via the poll message 1306), such as described in connection with FIGS. 8 and 11. Then, the first wireless device 1302 may receive the response message 1308 from the at least one second wireless device 1304 during the CAP. The CAP may include multiple slots, and the at least one second wireless device 1304 may transmit the response message 1308 to the first wireless device 1302 using one of the multiple slots, such as described in connection with FIG. 7A. The at least one second wireless device 1304 may select the slot randomly (e.g., based on a random selection). In some examples, as described in connection with FIGS. 8 and 11, the CAP may further be associated with a CFP (e.g., the at least one ranging round is a hybrid-based ranging round).

In another example, the first wireless device 1302 may transmit an indication of a response transmission time (e.g., a specified period of time) within a CFP to the at least one second wireless device 1304 (e.g., via the poll message 1306), such as described in connection with FIGS. 8 and 11. In response, the at least one second wireless device 1304 may transmit the response message 1308 to the first wireless device 1302 at the response transmission time. Such configuration may enable the at least one second wireless device 1304 to achieve power saving, where the at least one second wireless device 1304 may refrain from transmitting the response message 1308 outside the response transmission time. Similarly, as described in connection with FIGS. 8 and 11, the CFP may further be associated with a CAP (e.g., the at least one ranging round is a hybrid-based ranging round).

In another example, as described in connection with FIG. 11, the first wireless device 1302 may transmit an indication of multiple response phases (e.g., multiple CFP/CAP phases) to the at least one second wireless device 1304 (e.g., via the poll message 1306), where each of the multiple response phases may correspond to a QoS level. Based on the indicated multiple response phases, the at least one second wireless device 1304 may transmit the response message 1308 to the first wireless device 1302 via a response phase from the multiple response phases based on the QoS associated with the response phase.

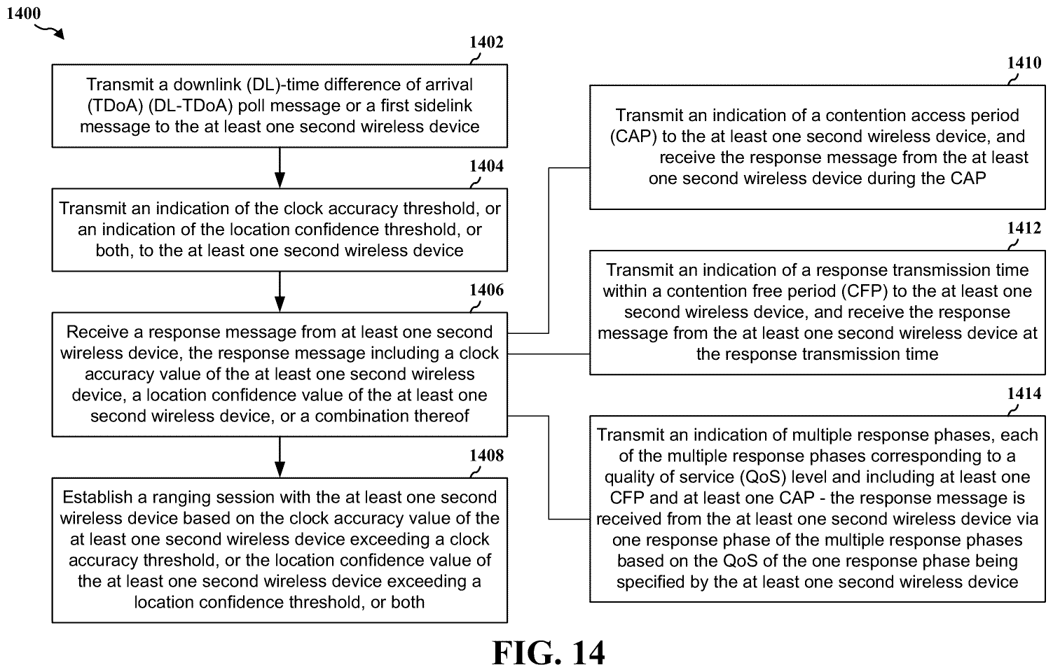

FIG. 14 is a flowchart 1400 of a method of wireless communication. The method may be performed by a first wireless device (e.g., the UE 104, 404; the controller 502; the controlee 504; the initiator 506; the initiator anchor 902, 1202; the first wireless device 1302; the apparatus 1604). The method may enable the first wireless device to establish a ranging session with one or more second wireless devices based on the clock accuracy and/or the location confidence associated with the one or more second wireless devices, thereby improving the accuracy and the reliability of the ranging session.

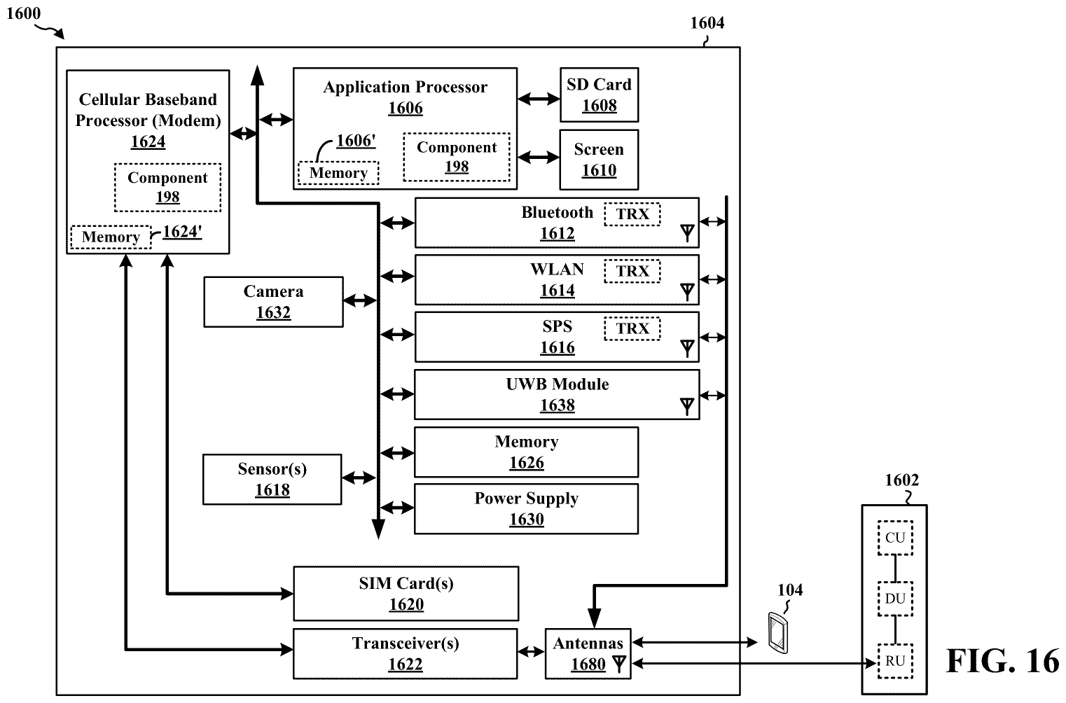

At 1406, the first wireless device may receive a response message from at least one second wireless device, the response message including a clock accuracy value of the at least one second wireless device, a location confidence value of the at least one second wireless device, or a combination thereof, such as described in connection with FIG. 13. For example, at 1314 of FIG. 13, the first wireless device 1302 may receive a response message 1308 from the at least one second wireless device 1304, where the response message 1308 may include a clock accuracy and/or a location confidence associated with the at least one second wireless device 1304. The reception of the response message may be performed by, e.g., the ranging component 198, the application processor 1606, the cellular baseband processor 1624, the UWB module 1638, and/or the transceiver(s) 1622 of the apparatus 1604 in FIG. 16.

In one example, the first wireless device may be a controller anchor or a first sidelink device, and the at least one second wireless device may be a responder anchor or a second sidelink device.

In another example, the ranging session may be an ultra-wideband (UWB) ranging session or a sidelink ranging session.

At 1408, the first wireless device may establish a ranging session with the at least one second wireless device based on the clock accuracy value of the at least one second wireless device exceeding a clock accuracy threshold, or the location confidence value of the at least one second wireless device exceeding a location confidence threshold, or both, such as described in connection with FIG. 13. For example, at 1316 of FIG. 13, the first wireless device 1302 may establish a ranging session 1310 with the at least one second wireless device 1304 based on the clock accuracy of the at least one second wireless device 1304 exceeding a clock accuracy threshold and/or the location confidence the at least one second wireless device 1304 exceeding a location confidence threshold. The establishment of the ranging session may be performed by, e.g., the ranging component 198, the application processor 1606, the cellular baseband processor 1624, the UWB module 1638, and/or the transceiver(s) 1622 of the apparatus 1604 in FIG. 16.

In one example, the response message may be a downlink (DL)-time difference of arrival (TDoA) (DL-TDoA) response message or a second sidelink message. Then, as shown at 1402, the first wireless device may transmit a DL-TDoA poll message or a first sidelink message to the at least one second wireless device, where the DL-TDoA response message or the second sidelink message is received from the at least one second wireless device based on the DL-TDoA poll message or the first sidelink message, such as described in connection with FIGS. 9, and 11 to 13. The transmission of the DL-TDoA poll message or the first sidelink message may be performed by, e.g., the ranging component 198, the application processor 1606, the cellular baseband processor 1624, the UWB module 1638, and/or the transceiver(s) 1622 of the apparatus 1604 in FIG. 16.

In another example, as shown at 1404, the first wireless device may transmit an indication of the clock accuracy threshold, or an indication of the location confidence threshold, or both, to the at least one second wireless device, such as described in connection with FIG. 13. For example, at 1312 of FIG. 13, the poll message 1306 may include a clock accuracy threshold and/or a location confidence threshold. The transmission of the indication may be performed by, e.g., the ranging component 198, the application processor 1606, the cellular baseband processor 1624, the UWB module 1638, and/or the transceiver(s) 1622 of the apparatus 1604 in FIG. 16.

In another example, as shown at 1410, the first wireless device may transmit an indication of a CAP to the at least one second wireless device, and receive the response message from the at least one second wireless device during the CAP, such as described in connection with FIGS. 7A, 7B, 8, 11, and 13. For example, the first wireless device 1302 may transmit an indication of a CAP to the at least one second wireless device 1304 (e.g., via the poll message 1306), and the first wireless device 1302 may receive the response message 1308 from the at least one second wireless device 1304 during the CAP (e.g., via one of the slots in CAP). The transmission of the indication and/or the reception of the response message may be performed by, e.g., the ranging component 198, the application processor 1606, the cellular baseband processor 1624, the UWB module 1638, and/or the transceiver(s) 1622 of the apparatus 1604 in FIG. 16. In some implementations, the CAP may include multiple slots, and the response message may be received from the at least one second wireless device at one of the multiple slots based on a random selection. In some implementations, the CAP may be further associated with a CFP.

In another example, as shown at 1412, the first wireless device may transmit an indication of a response transmission time within a CFP to the at least one second wireless device, and receive the response message from the at least one second wireless device at the response transmission time, such as described in connection with FIGS. 8, 11, and 13. For example, the first wireless device 1302 may transmit an indication of a CFP to the at least one second wireless device 1304 (e.g., via the poll message 1306), and the first wireless device 1302 may receive the response message 1308 from the at least one second wireless device 1304 during the CFP (e.g., via one of the slots in CFP). The transmission of the indication and/or the reception of the response message may be performed by, e.g., the ranging component 198, the application processor 1606, the cellular baseband processor 1624, the UWB module 1638, and/or the transceiver(s) 1622 of the apparatus 1604 in FIG. 16. In some implementations, the CFP may be further associated with a CAP.

In another example, as shown at 1414, the first wireless device may transmit an indication of multiple response phases, each of the multiple response phases corresponding to a quality of service (QOS) level and including at least one CFP and at least one CAP, where the response message is received from the at least one second wireless device via one response phase of the multiple response phases based on the QoS of the one response phase being specified by the at least one second wireless device, such as described in connection with FIGS. 11 and 13. For example, the first wireless device 1302 may transmit an indication of multiple CAP/CFP response phases, where each of the multiple CAP/CFP response phases may correspond to a particular QoS level. Then, the first wireless device 1302 may receive the response message 1308 received from the at least one second wireless device 1304 via one CAP/CFP response phase based on the QoS level. The transmission of the indication and/or the reception of the response message may be performed by, e.g., the ranging component 198, the application processor 1606, the cellular baseband processor 1624, the UWB module 1638, and/or the transceiver(s) 1622 of the apparatus 1604 in FIG. 16.

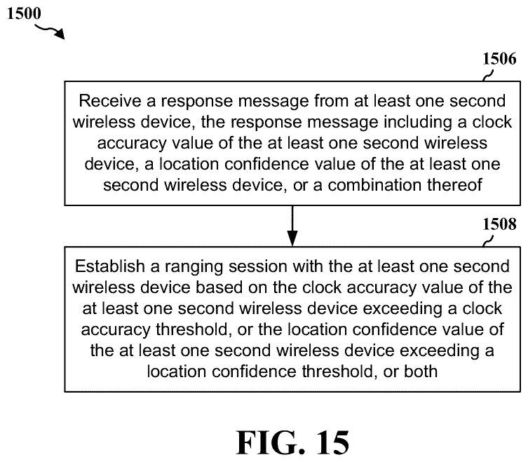

FIG. 15 is a flowchart 1500 of a method of wireless communication. The method may be performed by a first wireless device (e.g., the UE 104, 404; the controller 502; the controlee 504; the initiator 506; the initiator anchor 902, 1202; the first wireless device 1302; the apparatus 1604). The method may enable the first wireless device to establish a ranging session with one or more second wireless devices based on the clock accuracy and/or the location confidence associated with the one or more second wireless devices, thereby improving the accuracy and the reliability of the ranging session.

At 1506, the first wireless device may receive a response message from at least one second wireless device, the response message including a clock accuracy value of the at least one second wireless device, a location confidence value of the at least one second wireless device, or a combination thereof, such as described in connection with FIG. 13. For example, at 1314 of FIG. 13, the first wireless device 1302 may receive a response message 1308 from the at least one second wireless device 1304, where the response message 1308 may include a clock accuracy and/or a location confidence associated with the at least one second wireless device 1304. The reception of the response message may be performed by, e.g., the ranging component 198, the application processor 1606, the cellular baseband processor 1624, the UWB module 1638, and/or the transceiver(s) 1622 of the apparatus 1604 in FIG. 16.

In one example, the first wireless device may be a controller anchor or a first sidelink device, and the at least one second wireless device may be a responder anchor or a second sidelink device.

In another example, the ranging session may be an UWB ranging session or a sidelink ranging session.

At 1508, the first wireless device may establish a ranging session with the at least one second wireless device based on the clock accuracy value of the at least one second wireless device exceeding a clock accuracy threshold, or the location confidence value of the at least one second wireless device exceeding a location confidence threshold, or both, such as described in connection with FIG. 13. For example, at 1316 of FIG. 13, the first wireless device 1302 may establish a ranging session 1310 with the at least one second wireless device 1304 based on the clock accuracy of the at least one second wireless device 1304 exceeding a clock accuracy threshold and/or the location confidence the at least one second wireless device 1304 exceeding a location confidence threshold. The establishment of the ranging session may be performed by, e.g., the ranging component 198, the application processor 1606, the cellular baseband processor 1624, the UWB module 1638, and/or the transceiver(s) 1622 of the apparatus 1604 in FIG. 16.

In one example, the response message may be a DL-TDoA response message or a second sidelink message. Then, the first wireless device may transmit a DL-TDoA poll message or a first sidelink message to the at least one second wireless device, where the DL-TDoA response message or the second sidelink message is received from the at least one second wireless device based on the DL-TDoA poll message or the first sidelink message, such as described in connection with FIGS. 9, and 11 to 13. The transmission of the DL-TDoA poll message or the first sidelink message may be performed by, e.g., the ranging component 198, the application processor 1606, the cellular baseband processor 1624, the UWB module 1638, and/or the transceiver(s) 1622 of the apparatus 1604 in FIG. 16.

In another example, the first wireless device may transmit an indication of the clock accuracy threshold, or an indication of the location confidence threshold, or both, to the at least one second wireless device, such as described in connection with FIG. 13. For example, at 1312 of FIG. 13, the poll message 1306 may include a clock accuracy threshold and/or a location confidence threshold. The transmission of the indication may be performed by, e.g., the ranging component 198, the application processor 1606, the cellular baseband processor 1624, the UWB module 1638, and/or the transceiver(s) 1622 of the apparatus 1604 in FIG. 16.

In another example, the first wireless device may transmit an indication of a CAP to the at least one second wireless device, and receive the response message from the at least one second wireless device during the CAP, such as described in connection with FIGS. 7A, 7B, 8, 11, and 13. For example, the first wireless device 1302 may transmit an indication of a CAP to the at least one second wireless device 1304 (e.g., via the poll message 1306), and the first wireless device 1302 may receive the response message 1308 from the at least one second wireless device 1304 during the CAP (e.g., via one of the slots in CAP). The transmission of the indication and/or the reception of the response message may be performed by, e.g., the ranging component 198, the application processor 1606, the cellular baseband processor 1624, the UWB module 1638, and/or the transceiver(s) 1622 of the apparatus 1604 in FIG. 16. In some implementations, the CAP may include multiple slots, and the response message may be received from the at least one second wireless device at one of the multiple slots based on a random selection. In some implementations, the CAP may be further associated with a CFP.

In another example, the first wireless device may transmit an indication of a response transmission time within a CFP to the at least one second wireless device, and receive the response message from the at least one second wireless device at the response transmission time, such as described in connection with FIGS. 8, 11, and 13. For example, the first wireless device 1302 may transmit an indication of a CFP to the at least one second wireless device 1304 (e.g., via the poll message 1306), and the first wireless device 1302 may receive the response message 1308 from the at least one second wireless device 1304 during the CFP (e.g., via one of the slots in CFP). The transmission of the indication and/or the reception of the response message may be performed by, e.g., the ranging component 198, the application processor 1606, the cellular baseband processor 1624, the UWB module 1638, and/or the transceiver(s) 1622 of the apparatus 1604 in FIG. 16. In some implementations, the CFP may be further associated with a CAP.

In another example, the first wireless device may transmit an indication of multiple response phases, each of the multiple response phases corresponding to a QoS level and including at least one CFP and at least one CAP, where the response message is received from the at least one second wireless device via one response phase of the multiple response phases based on the QoS of the one response phase being specified by the at least one second wireless device, such as described in connection with FIGS. 11 and 13. For example, the first wireless device 1302 may transmit an indication of multiple CAP/CFP response phases, where each of the multiple CAP/CFP response phases may correspond to a particular QoS level. Then, the first wireless device 1302 may receive the response message 1308 received from the at least one second wireless device 1304 via one CAP/CFP response phase based on the QoS level. The transmission of the indication and/or the reception of the response message may be performed by, e.g., the ranging component 198, the application processor 1606, the cellular baseband processor 1624, the UWB module 1638, and/or the transceiver(s) 1622 of the apparatus 1604 in FIG. 16.

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, a Ultrawideband (UWB) module 1638, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see UE 350 of FIG. 3) and include the additional modules of the apparatus 1604.

As discussed supra, the ranging component 198 may be configured to receive a response message from at least one second wireless device, the response message including a clock accuracy value of the at least one second wireless device, a location confidence value of the at least one second wireless device, or a combination thereof. The ranging component 198 may also be configured to establish a ranging session with the at least one second wireless device based on the clock accuracy value of the at least one second wireless device exceeding a clock accuracy threshold, or the location confidence value of the at least one second wireless device exceeding a location confidence threshold, or both. The ranging component 198 may be within the cellular baseband processor 1624, the application processor 1606, or both the cellular baseband processor 1624 and the application processor 1606. The ranging component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, may include means for receiving a response message from at least one second wireless device, the response message including a clock accuracy value of the at least one second wireless device, a location confidence value of the at least one second wireless device, or a combination thereof. The apparatus 1604 may further include means for establishing a ranging session with the at least one second wireless device based on the clock accuracy value of the at least one second wireless device exceeding a clock accuracy threshold, or the location confidence value of the at least one second wireless device exceeding a location confidence threshold, or both.

In one configuration, the apparatus 1604 may be a controller anchor or a first sidelink device, and the at least one second wireless device may be a responder anchor or a second sidelink device.

In another configuration, the ranging session may be an UWB ranging session or a sidelink ranging session.

In another configuration, the response message may be a DL-TDoA response message or a second sidelink message. The apparatus 1604 may further include means for transmitting a DL-TDoA poll message or a first sidelink message to the at least one second wireless device, where the DL-TDoA response message or the second sidelink message is received from the at least one second wireless device based on the DL-TDoA poll message or the first sidelink message.

In another configuration, the apparatus 1604 may further include means for transmitting an indication of the clock accuracy threshold, or an indication of the location confidence threshold, or both, to the at least one second wireless device.

In another configuration, the apparatus 1604 may further include means for transmitting an indication of a CAP to the at least one second wireless device, and means for receiving the response message from the at least one second wireless device during the CAP. In some implementations, the CAP may include multiple slots, and the response message may be received from the at least one second wireless device at one of the multiple slots based on a random selection. In some implementations, the CAP may be further associated with a CFP.

In another configuration, the apparatus 1604 may further include means for transmitting an indication of a response transmission time within a CFP to the at least one second wireless device, and means for receiving the response message from the at least one second wireless device at the response transmission time. In some implementations, the CFP may be further associated with a CAP.

In another configuration, the apparatus 1604 may further include means for transmitting an indication of multiple response phases, each of the multiple response phases corresponding to a QoS level and including at least one CFP and at least one CAP, where the response message is received from the at least one second wireless device via one response phase of the multiple response phases based on the QoS of the one response phase being specified by the at least one second wireless device.

The means may be the ranging component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

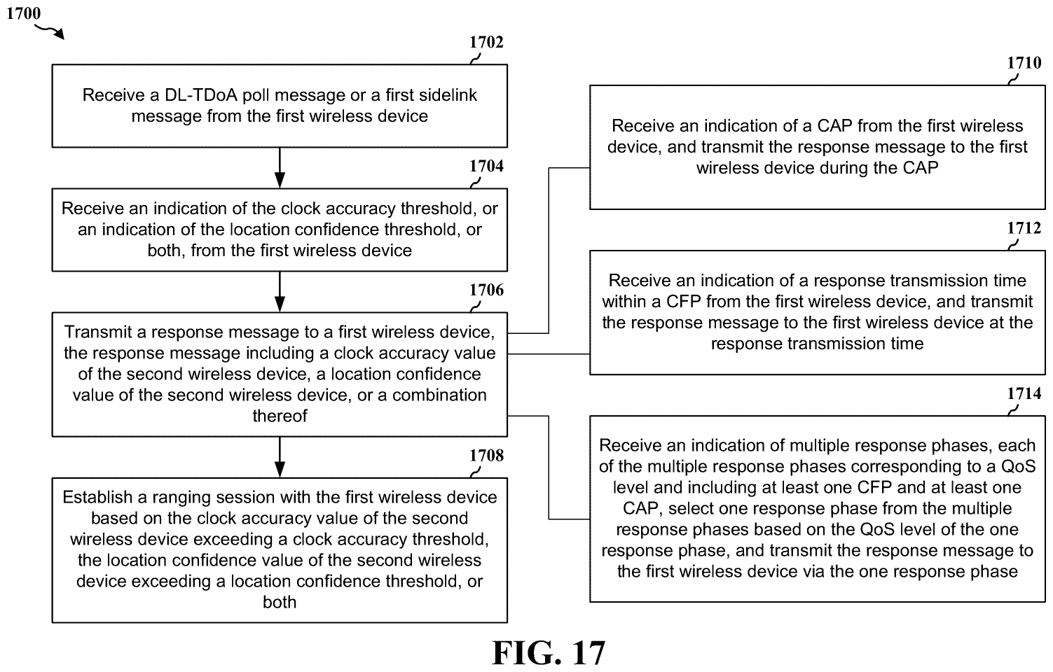

FIG. 17 is a flowchart 1700 of a method of wireless communication. The method may be performed by a second wireless device (e.g., the UE 104, 404; the controller 502; the controlee 504; the responder 508; the responder anchor 904, 906, 908, 1204; the new anchor 1206; the at least one second wireless device 1304; the apparatus 1904). The method may enable the second wireless device to join a ranging session established by a first wireless devices based on the clock accuracy and/or the location confidence associated with the second wireless devices, thereby improving the accuracy and the reliability of the ranging session.

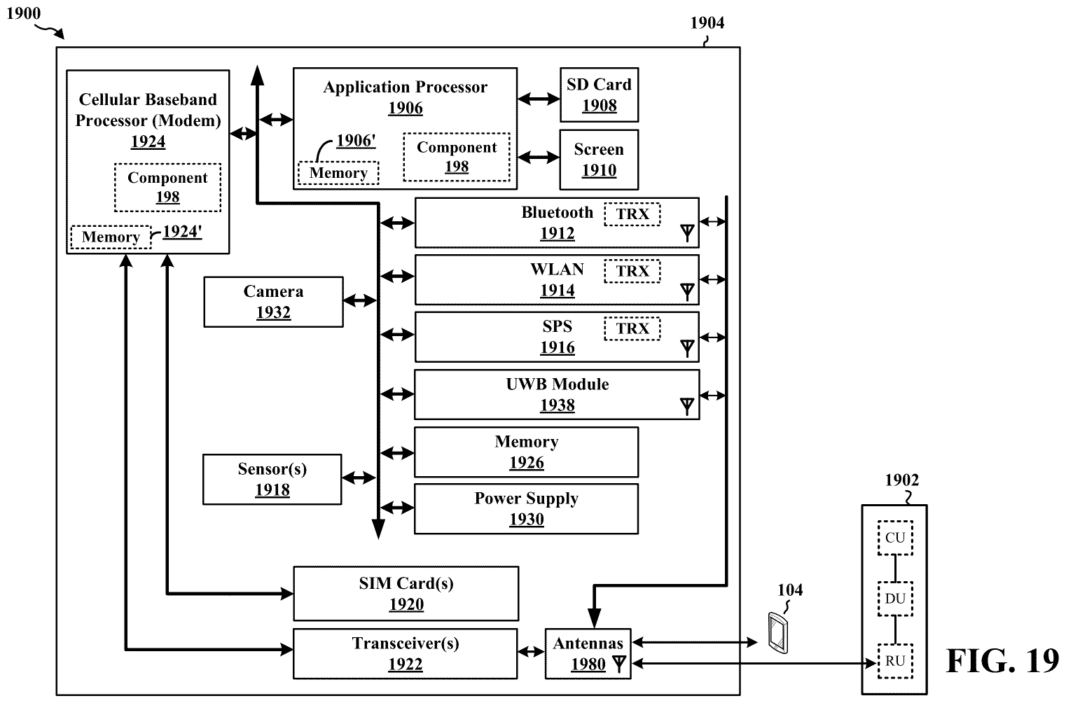

At 1706, the second wireless device may transmit a response message to a first wireless device, the response message including a clock accuracy value of the second wireless device, a location confidence value of the second wireless device, or a combination thereof, such as described in connection with FIG. 13. For example, at 1314 of FIG. 13, the second wireless device 1304 may transmit a response message 1308 to the first wireless device 1302, where the response message 1308 may include a clock accuracy and/or a location confidence associated with the at least one second wireless device 1304. The transmission of the response message may be performed by, e.g., the ranging component 198, the application processor 1906, the cellular baseband processor 1924, the UWB module 1938, and/or the transceiver(s) 1922 of the apparatus 1904 in FIG. 19.

In one example, the first wireless device may be a controller anchor or a first sidelink device, and the second wireless device may be a responder anchor or a second sidelink device.

In another example, the ranging session may be an UWB ranging session or a sidelink ranging session.

At 1708, the second wireless device may establish a ranging session with the first wireless device based on the clock accuracy value of the second wireless device exceeding a clock accuracy threshold, the location confidence value of the second wireless device exceeding a location confidence threshold, or both, such as described in connection with FIG. 13. For example, at 1316 of FIG. 13, the at least one second wireless device 1304 may establish a ranging session 1310 with the first wireless device 1302 based on the clock accuracy of the at least one second wireless device 1304 exceeding a clock accuracy threshold and/or the location confidence the at least one second wireless device 1304 exceeding a location confidence threshold. The establishment of the ranging session may be performed by, e.g., the ranging component 198, the application processor 1906, the cellular baseband processor 1924, the UWB module 1938, and/or the transceiver(s) 1922 of the apparatus 1904 in FIG. 19.

In one example, the response message may be a DL-TDoA response message or a second sidelink message. Then, as shown at 1702, the second wireless device may receive a DL-TDoA poll message or a first sidelink message from the first wireless device, where the DL-TDoA response message or the second sidelink message is transmitted to the first wireless device based on the DL-TDoA poll message or the first sidelink message, such as described in connection with FIGS. 9, and 11 to 13. The reception of the DL-TDoA response message or the second sidelink message may be performed by, e.g., the ranging component 198, the application processor 1906, the cellular baseband processor 1924, the UWB module 1938, and/or the transceiver(s) 1922 of the apparatus 1904 in FIG. 19.

In another example, as shown at 1704, the second wireless device may receive an indication of the clock accuracy threshold, or an indication of the location confidence threshold, or both, from the first wireless device, such as described in connection with FIG. 13. For example, at 1312 of FIG. 13, the poll message 1306 may include a clock accuracy threshold and/or a location confidence threshold. The reception of the indication may be performed by, e.g., the ranging component 198, the application processor 1906, the cellular baseband processor 1924, the UWB module 1938, and/or the transceiver(s) 1922 of the apparatus 1904 in FIG. 19.

In another example, as shown at 1710, the second wireless device may receive an indication of a CAP from the first wireless device, and transmit the response message to the first wireless device during the CAP, such as described in connection with FIGS. 7A, 7B, 8, 11, and 13. For example, the at least one second wireless device 1304 may receive an indication of a CAP from the first wireless device 1302 (e.g., via the poll message 1306), and the at least one second wireless device 1304 may transmit the response message 1308 to the first wireless device 1302 during the CAP (e.g., via one of the slots in CAP). The reception of the indication and/or the transmission of the response message may be performed by, e.g., the ranging component 198, the application processor 1906, the cellular baseband processor 1924, the UWB module 1938, and/or the transceiver(s) 1922 of the apparatus 1904 in FIG. 19. In some implementations, the CAP may include multiple slots, and the response message may be transmitted to the first wireless device at one of the multiple slots based on a random selection. In some implementations, the CAP may be further associated with a CFP.

In another example, as shown at 1712, the second wireless device may receive an indication of a response transmission time within a CFP from the first wireless device, and transmit the response message to the first wireless device at the response transmission time, such as described in connection with FIGS. 8, 11, and 13. For example, the at least one second wireless device 1304 may receive an indication of a CFP from the first wireless device 1302 (e.g., via the poll message 1306), and the at least one second wireless device 1304 may transmit the response message 1308 to the first wireless device 1302 during the CFP (e.g., via one of the slots in CFP). The reception of the indication and/or the transmission of the response message may be performed by, e.g., the ranging component 198, the application processor 1906, the cellular baseband processor 1924, the UWB module 1938, and/or the transceiver(s) 1922 of the apparatus 1904 in FIG. 19. In some implementations, the CFP may be further associated with a CAP.

In another example, as shown at 1714, the second wireless device may receive an indication of multiple response phases, each of the multiple response phases corresponding to a QoS level and including at least one CFP and at least one CAP, select one response phase from the multiple response phases based on the QoS level of the one response phase, and transmit the response message to the first wireless device via the one response phase, such as described in connection with FIGS. 11 and 13. For example, the at least one second wireless device 1304 may receive an indication of multiple CAP/CFP response phases, where each of the multiple CAP/CFP response phases may correspond to a particular QoS level. The at least one second wireless device 1304 may select a CAP/CFP response phase, and then the at least one second wireless device 1304 may transmit the response message 1308 to the first wireless device 1302 via the selected CAP/CFP response phase based on the QoS level. The reception of the indication and/or the transmission of the response message may be performed by, e.g., the ranging component 198, the application processor 1906, the cellular baseband processor 1924, the UWB module 1938, and/or the transceiver(s) 1922 of the apparatus 1904 in FIG. 19.

In another example, the second wireless device may estimate a position of the second wireless device based on DL-TDoA, and transmit the response message based on the estimated position of the second wireless device.

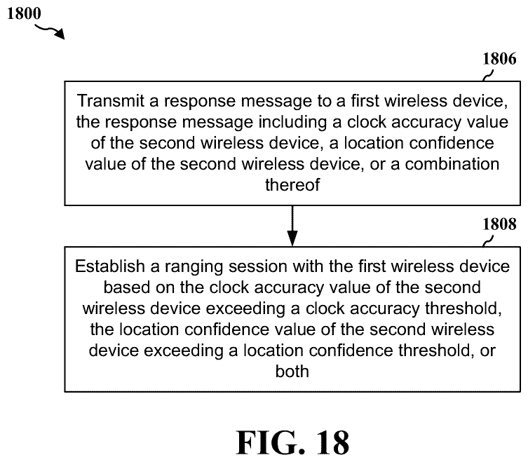

FIG. 18 is a flowchart 1800 of a method of wireless communication. The method may be performed by a second wireless device (e.g., the UE 104, 404; the controller 502; the controlee 504; the responder 508; the responder anchor 904, 906, 908, 1204; the new anchor 1206; the at least one second wireless device 1304; the apparatus 1904). The method may enable the second wireless device to join a ranging session established by a first wireless devices based on the clock accuracy and/or the location confidence associated with the second wireless devices, thereby improving the accuracy and the reliability of the ranging session.

At 1806, the second wireless device may transmit a response message to a first wireless device, the response message including a clock accuracy value of the second wireless device, a location confidence value of the second wireless device, or a combination thereof, such as described in connection with FIG. 13. For example, at 1314 of FIG. 13, the second wireless device 1304 may transmit a response message 1308 to the first wireless device 1302, where the response message 1308 may include a clock accuracy and/or a location confidence associated with the at least one second wireless device 1304. The transmission of the response message may be performed by, e.g., the ranging component 198, the application processor 1906, the cellular baseband processor 1924, the UWB module 1938, and/or the transceiver(s) 1922 of the apparatus 1904 in FIG. 19.

In one example, the first wireless device may be a controller anchor or a first sidelink device, and the second wireless device may be a responder anchor or a second sidelink device.

In another example, the ranging session may be an UWB ranging session or a sidelink ranging session.

At 1808, the second wireless device may establish a ranging session with the first wireless device based on the clock accuracy value of the second wireless device exceeding a clock accuracy threshold, the location confidence value of the second wireless device exceeding a location confidence threshold, or both, such as described in connection with FIG. 13. For example, at 1316 of FIG. 13, the at least one second wireless device 1304 may establish a ranging session 1310 with the first wireless device 1302 based on the clock accuracy of the at least one second wireless device 1304 exceeding a clock accuracy threshold and/or the location confidence the at least one second wireless device 1304 exceeding a location confidence threshold. The establishment of the ranging session may be performed by, e.g., the ranging component 198, the application processor 1906, the cellular baseband processor 1924, the UWB module 1938, and/or the transceiver(s) 1922 of the apparatus 1904 in FIG. 19.

In one example, the response message may be a DL-TDoA response message or a second sidelink message. Then, the second wireless device may receive a DL-TDoA poll message or a first sidelink message from the first wireless device, where the DL-TDoA response message or the second sidelink message is transmitted to the first wireless device based on the DL-TDoA poll message or the first sidelink message, such as described in connection with FIGS. 9, and 11 to 13. The reception of the DL-TDoA response message or the second sidelink message may be performed by, e.g., the ranging component 198, the application processor 1906, the cellular baseband processor 1924, the UWB module 1938, and/or the transceiver(s) 1922 of the apparatus 1904 in FIG. 19.

In another example, the second wireless device may receive an indication of the clock accuracy threshold, or an indication of the location confidence threshold, or both, from the first wireless device, such as described in connection with FIG. 13. For example, at 1312 of FIG. 13, the poll message 1306 may include a clock accuracy threshold and/or a location confidence threshold. The reception of the indication may be performed by, e.g., the ranging component 198, the application processor 1906, the cellular baseband processor 1924, the UWB module 1938, and/or the transceiver(s) 1922 of the apparatus 1904 in FIG. 19.

In another example, the second wireless device may receive an indication of a CAP from the first wireless device, and transmit the response message to the first wireless device during the CAP, such as described in connection with FIGS. 7A, 7B, 8, 11, and 13. For example, the at least one second wireless device 1304 may receive an indication of a CAP from the first wireless device 1302 (e.g., via the poll message 1306), and the at least one second wireless device 1304 may transmit the response message 1308 to the first wireless device 1302 during the CAP (e.g., via one of the slots in CAP). The reception of the indication and/or the transmission of the response message may be performed by, e.g., the ranging component 198, the application processor 1906, the cellular baseband processor 1924, the UWB module 1938, and/or the transceiver(s) 1922 of the apparatus 1904 in FIG. 19. In some implementations, the CAP may include multiple slots, and the response message may be transmitted to the first wireless device at one of the multiple slots based on a random selection. In some implementations, the CAP may be further associated with a CFP.

In another example, the second wireless device may receive an indication of a response transmission time within a CFP from the first wireless device, and transmit the response message to the first wireless device at the response transmission time, such as described in connection with FIGS. 8, 11, and 13. For example, the at least one second wireless device 1304 may receive an indication of a CFP from the first wireless device 1302 (e.g., via the poll message 1306), and the at least one second wireless device 1304 may transmit the response message 1308 to the first wireless device 1302 during the CFP (e.g., via one of the slots in CFP). The reception of the indication and/or the transmission of the response message may be performed by, e.g., the ranging component 198, the application processor 1906, the cellular baseband processor 1924, the UWB module 1938, and/or the transceiver(s) 1922 of the apparatus 1904 in FIG. 19. In some implementations, the CFP may be further associated with a CAP.

In another example, the second wireless device may receive an indication of multiple response phases, each of the multiple response phases corresponding to a QoS level and including at least one CFP and at least one CAP, select one response phase from the multiple response phases based on the QoS level of the one response phase, and transmit the response message to the first wireless device via the one response phase, such as described in connection with FIGS. 11 and 13. For example, the at least one second wireless device 1304 may receive an indication of multiple CAP/CFP response phases, where each of the multiple CAP/CFP response phases may correspond to a particular QoS level. The at least one second wireless device 1304 may select a CAP/CFP response phase, and then the at least one second wireless device 1304 may transmit the response message 1308 to the first wireless device 1302 via the selected CAP/CFP response phase based on the QoS level. The reception of the indication and/or the transmission of the response message may be performed by, e.g., the ranging component 198, the application processor 1906, the cellular baseband processor 1924, the UWB module 1938, and/or the transceiver(s) 1922 of the apparatus 1904 in FIG. 19.

In another example, the second wireless device may estimate a position of the second wireless device based on DL-TDoA, and transmit the response message based on the estimated position of the second wireless device.

FIG. 19 is a diagram 1900 illustrating an example of a hardware implementation for an apparatus 1904. The apparatus 1904 may be a UE, a component of a UE, or may implement UE functionality. In some aspects, the apparatus 1904 may include a cellular baseband processor 1924 (also referred to as a modem) coupled to one or more transceivers 1922 (e.g., cellular RF transceiver). The cellular baseband processor 1924 may include on-chip memory 1924′. In some aspects, the apparatus 1904 may further include one or more subscriber identity modules (SIM) cards 1920 and an application processor 1906 coupled to a secure digital (SD) card 1908 and a screen 1910. The application processor 1906 may include on-chip memory 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the WLAN module 1914, a Ultrawideband (UWB) module 1938, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize the antennas 1980 for communication. The cellular baseband processor 1924 communicates through the transceiver(s) 1922 via one or more antennas 1980 with the UE 104 and/or with an RU associated with a network entity 1902. The cellular baseband processor 1924 and the application processor 1906 may each include a computer-readable medium/memory 1924′, 1906′, respectively. The additional memory modules 1926 may also be considered a computer-readable medium/memory. Each computer-readable medium/memory 1924′, 1906′, 1926 may be non-transitory. The cellular baseband processor 1924 and the application processor 1906 are each responsible for general processing, including the execution of software stored on the computer-readable medium/memory. The software, when executed by the cellular baseband processor 1924/application processor 1906, causes the cellular baseband processor 1924/application processor 1906 to perform the various functions described supra. The computer-readable medium/memory may also be used for storing data that is manipulated by the cellular baseband processor 1924/application processor 1906 when executing software. The cellular baseband processor 1924/application processor 1906 may be a component of the UE 350 and may include the memory 360 and/or at least one of the TX processor 368, the RX processor 356, and the controller/processor 359. In one configuration, the apparatus 1904 may be a processor chip (modem and/or application) and include just the cellular baseband processor 1924 and/or the application processor 1906, and in another configuration, the apparatus 1904 may be the entire UE (e.g., see UE 350 of FIG. 3) and include the additional modules of the apparatus 1904.

As discussed supra, the ranging component 198 may be configured to transmit a response message to a first wireless device, the response message including a clock accuracy value of the apparatus 1904, a location confidence value of the apparatus 1904, or a combination thereof. The ranging component 198 may also be configured to establish a ranging session with the first wireless device based on the clock accuracy value of the apparatus 1904 exceeding a clock accuracy threshold, the location confidence value of the apparatus 1904 exceeding a location confidence threshold, or both. The ranging component 198 may be within the cellular baseband processor 1924, the application processor 1906, or both the cellular baseband processor 1924 and the application processor 1906. The ranging component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1904 may include a variety of components configured for various functions. In one configuration, the apparatus 1904, and in particular the cellular baseband processor 1924 and/or the application processor 1906, may include means for transmitting a response message to a first wireless device, the response message including a clock accuracy value of the apparatus 1904, a location confidence value of the apparatus 1904, or a combination thereof. The apparatus 1904 may further include means for establishing a ranging session with the first wireless device based on the clock accuracy value of the apparatus 1904 exceeding a clock accuracy threshold, the location confidence value of the apparatus 1904 exceeding a location confidence threshold, or both.

In one configuration, the first wireless device may be a controller anchor or a first sidelink device, and the apparatus 1904 may be a responder anchor or a second sidelink device.

In another configuration, the ranging session may be an UWB ranging session or a sidelink ranging session.

In another configuration, the response message may be a DL-TDoA response message or a second sidelink message. The apparatus 1904 may further include means for receiving a DL-TDoA poll message or a first sidelink message from the first wireless device, where the DL-TDoA response message or the second sidelink message is transmitted to the first wireless device based on the DL-TDoA poll message or the first sidelink message.

In another configuration, the apparatus 1904 may further include means for receiving an indication of the clock accuracy threshold, or an indication of the location confidence threshold, or both, from the first wireless device.

In another configuration, the apparatus 1904 may further include means for receiving an indication of a CAP from the first wireless device, and means for transmitting the response message to the first wireless device during the CAP. In some implementations, the CAP may include multiple slots, and the response message may be transmitted to the first wireless device at one of the multiple slots based on a random selection. In some implementations, the CAP may be further associated with a CFP.

In another configuration, the apparatus 1904 may further include means for receiving an indication of a response transmission time within a CFP from the first wireless device, and means for transmitting the response message to the first wireless device at the response transmission time. In some implementations, the CFP may be further associated with a CAP.

In another configuration, the apparatus 1904 may further include means for receiving an indication of multiple response phases, each of the multiple response phases corresponding to a QoS level and including at least one CFP and at least one CAP, means for selecting one response phase from the multiple response phases based on the QoS level of the one response phase, and means for transmitting the response message to the first wireless device via the one response phase.

In another configuration, the apparatus 1904 may further include means for estimating a position of the apparatus 1904 based on DL-TDoA, and means for transmitting the response message based on the estimated position of the apparatus 1904.

The means may be the ranging component 198 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at first wireless device, including: receiving a response message from at least one second wireless device, the response message including a clock accuracy value of the at least one second wireless device, a location confidence value of the at least one second wireless device, or a combination thereof; and establishing a ranging session with the at least one second wireless device based on the clock accuracy value of the at least one second wireless device exceeding a clock accuracy threshold, or the location confidence value of the at least one second wireless device exceeding a location confidence threshold, or both.

Aspect 2 is the method of aspect 1, where the first wireless device is a controller anchor or a first sidelink device, and where the at least one second wireless device is a responder anchor or a second sidelink device.

Aspect 3 is the method of aspect 1 or 2, where the ranging session is an ultra-wideband (UWB) ranging session or a sidelink ranging session.

Aspect 4 is the method of any of aspects 1 to 3, where the response message is a downlink (DL)-time difference of arrival (TDoA) (DL-TDoA) response message or a second sidelink message.

Aspect 5 is the method of aspect 4, further including: transmitting a DL-TDoA poll message or a first sidelink message to the at least one second wireless device, where the DL-TDoA response message or the second sidelink message is received from the at least one second wireless device based on the DL-TDoA poll message or the first sidelink message.

Aspect 6 is the method of any of aspects 1 to 5, further including: transmitting an indication of a CAP to the at least one second wireless device; and receiving the response message from the at least one second wireless device during the CAP.

Aspect 7 is the method of aspect 6, where the CAP includes multiple slots, and the response message is received from the at least one second wireless device at one of the multiple slots based on a random selection.

Aspect 8 is the method of aspect 6, where the CAP is further associated with a CFP.

Aspect 9 is the method of any of aspects 1 to 8, further including: transmitting an indication of a response transmission time within a CFP to the at least one second wireless device; and receiving the response message from the at least one second wireless device at the response transmission time.

Aspect 10 is the method of aspect 9, where the CFP is further associated with a CAP.

Aspect 11 is the method of any of aspects 1 to 10, further including: transmitting an indication of the clock accuracy threshold, or an indication of the location confidence threshold, or both, to the at least one second wireless device.

Aspect 12 is the method of any of aspects 1 to 11, further including: transmitting an indication of multiple response phases, each of the multiple response phases corresponding to a QoS level and including at least one CFP and at least one CAP, where the response message is received from the at least one second wireless device via one response phase of the multiple response phases based on the QoS of the one response phase being specified by the at least one second wireless device.

Aspect 13 is an apparatus for wireless communication at a first wireless device, including: a memory; and at least one processor coupled to the memory and, based at least in part on information stored in the memory, the at least one processor is configured to implement any of aspects 1 to 12.

Aspect 14 is the apparatus of aspect 13, further including at least one of a transceiver or an antenna coupled to the at least one processor.

Aspect 15 is an apparatus for wireless communication including means for implementing any of aspects 1 to 12.

Aspect 16 is a computer-readable medium (e.g., a non-transitory computer-readable medium) storing computer executable code, where the code when executed by a processor causes the processor to implement any of aspects 1 to 12.

Aspect 17 is a method of wireless communication at a second wireless device, including: transmitting a response message to a first wireless device, the response message including a clock accuracy value of the second wireless device, a location confidence value of the second wireless device, or a combination thereof; and establishing a ranging session with the first wireless device based on the clock accuracy value of the second wireless device exceeding a clock accuracy threshold, the location confidence value of the second wireless device exceeding a location confidence threshold, or both.

Aspect 18 is the method of aspect 17, where the first wireless device is a controller anchor or a first sidelink device, and where the second wireless device is a responder anchor or a second sidelink device.

Aspect 19 is the method of aspect 17 or 18, where the ranging session is an UWB ranging session or a sidelink ranging session.

Aspect 20 is the method of any of aspects 17 to 19, where the response message is a DL-TDoA response message or a second sidelink message.

Aspect 21 is the method of aspect 20, further including: receiving a DL-TDoA poll message or a first sidelink message from the first wireless device, where the DL-TDoA response message or the second sidelink message is transmitted to the first wireless device based on the DL-TDoA poll message or the first sidelink message.

Aspect 22 is the method of any of aspects 17 to 21, further including: receiving an indication of a CAP from the first wireless device; and transmitting the response message to the first wireless device during the CAP.

Aspect 23 is the method of aspect 21, where the CAP includes multiple slots, and the response message is transmitted to the first wireless device at one of the multiple slots based on a random selection.

Aspect 24 is the method of aspect 21, where the CAP is further associated with a CFP.

Aspect 25 is the method of any of aspects 17 to 24, further including: receiving an indication of a response transmission time within a CFP from the first wireless device; and transmitting the response message to the first wireless device at the response transmission time.

Aspect 26 is the method of aspect 25, where the CFP is further associated with a CAP.

Aspect 27 is the method of any of aspects 17 to 26, further including: receiving an indication of the clock accuracy threshold, or an indication of the location confidence threshold, or both, from the first wireless device.

Aspect 28 is the method of any of aspects 17 to 27, where the response message is transmitted based on the clock accuracy value exceeding the clock accuracy threshold, the location confidence value exceeding the location confidence threshold, or both.

Aspect 29 is the method of any of aspects 17 to 28, further including: estimating a position of the second wireless device based on DL-TDoA; and transmitting the response message based on the estimated position of the second wireless device.

Aspect 30 is the method of any of aspects 17 to 29, further including: receiving an indication of multiple response phases, each of the multiple response phases corresponding to a QoS level and including at least one CFP and at least one CAP; selecting one response phase from the multiple response phases based on the Qos level of the one response phase; and transmitting the response message to the first wireless device via the one response phase.

Aspect 31 is an apparatus for wireless communication at a second wireless device, including: a memory; and at least one processor coupled to the memory and, based at least in part on information stored in the memory, the at least one processor is configured to implement any of aspects 17 to 30.

Aspect 32 is the apparatus of aspect 31, further including at least one of a transceiver or an antenna coupled to the at least one processor.

Aspect 33 is an apparatus for wireless communication including means for implementing any of aspects 17 to 30.

Aspect 34 is a computer-readable medium (e.g., a non-transitory computer-readable medium) storing computer executable code, where the code when executed by a processor causes the processor to implement any of aspects 17 to 30.

What is claimed is:

1. An apparatus for wireless communication at a first wireless device, comprising:
a memory;
at least one transceiver; and
at least one processor communicatively connected to the memory and the at least one transceiver, the at least one processor configured to:
receive a response message from at least one second wireless device, the response message including a clock accuracy value of the at least one second wireless device, a location confidence value of the at least one second wireless device, or a combination thereof; and
establish a ranging session with the at least one second wireless device based on the clock accuracy value of the at least one second wireless device exceeding a clock accuracy threshold, or the location confidence value of the at least one second wireless device exceeding a location confidence threshold, or both.

2. The apparatus of claim 1, wherein the first wireless device is a controller anchor or a first sidelink device, and wherein the at least one second wireless device is a responder anchor or a second sidelink device.

3. The apparatus of claim 1, wherein the ranging session is an ultra-wideband (UWB) ranging session or a sidelink ranging session.

4. The apparatus of claim 1, wherein the response message is a downlink (DL)-time difference of arrival (TDoA) (DL-TDoA) response message or a second sidelink message.

5. The apparatus of claim 4, wherein the at least one processor is further configured to:
transmit a DL-TDoA poll message or a first sidelink message to the at least one second wireless device, wherein the at least one processor is configured to receive the DL-TDoA response message or the second sidelink message from the at least one second wireless device based on the DL-TDoA poll message or the first sidelink message.

6. The apparatus of claim 1, wherein the at least one processor is further configured to:
transmit an indication of a contention access period (CAP) to the at least one second wireless device; and
receive the response message from the at least one second wireless device during the CAP.

7. The apparatus of claim 6, wherein the CAP includes multiple slots, and the at least one processor is configured to receive the response message from the at least one second wireless device at one of the multiple slots based on a random selection.

8. The apparatus of claim 6, wherein the CAP is further associated with a contention free period (CFP).

9. The apparatus of claim 1, wherein the at least one processor is further configured to:
transmit an indication of a response transmission time within a contention free period (CFP) to the at least one second wireless device; and
receive the response message from the at least one second wireless device at the response transmission time.

10. The apparatus of claim 9, wherein the CFP is further associated with a contention access period (CAP).

11. The apparatus of claim 1, wherein the at least one processor is further configured to:
transmit an indication of the clock accuracy threshold, or an indication of the location confidence threshold, or both, to the at least one second wireless device.

12. The apparatus of claim 1, wherein the at least one processor is further configured to:
transmit an indication of multiple response phases, each of the multiple response phases corresponding to a quality of service (QOS) level and including at least one contention free period (CFP) and at least one contention access period (CAP), wherein the at least one processor is configured to receive the response message from the at least one second wireless device via one response phase of the multiple response phases based on the QoS level of the one response phase being specified by the at least one second wireless device.

13. A method of wireless communication at a first wireless device, comprising:
receiving a response message from at least one second wireless device, the response message including a clock accuracy value of the at least one second wireless device, a location confidence value of the at least one second wireless device, or a combination thereof; and
establishing a ranging session with the at least one second wireless device based on the clock accuracy value of the at least one second wireless device exceeding a clock accuracy threshold, or the location confidence value of the at least one second wireless device exceeding a location confidence threshold, or both.

14. The method of claim 13, further comprising:
transmitting an indication of the clock accuracy threshold, or an indication of the location confidence threshold, or both, to the at least one second wireless device.

15. An apparatus for wireless communication at a second wireless device, comprising:
a memory;
at least one transceiver; and
at least one processor communicatively connected to the memory and the at least one transceiver, the at least one processor configured to:
transmit a response message to a first wireless device, the response message including a clock accuracy value of the second wireless device, a location confidence value of the second wireless device, or a combination thereof; and
establish a ranging session with the first wireless device based on the clock accuracy value of the second wireless device exceeding a clock accuracy threshold, the location confidence value of the second wireless device exceeding a location confidence threshold, or both.

16. The apparatus of claim 15, wherein the first wireless device is a controller anchor or a first sidelink device, and wherein the second wireless device is a responder anchor or a second sidelink device.

17. The apparatus of claim 15, wherein the ranging session is an ultra-wideband (UWB) ranging session or a sidelink ranging session.

18. The apparatus of claim 15, wherein the response message is a downlink (DL)-time difference of arrival (TDoA) (DL-TDoA) response message or a second sidelink message.

19. The apparatus of claim 18, wherein the at least one processor is further configured to:
receive a DL-TDoA poll message or a first sidelink message from the first wireless device, wherein the at least one processor is configured to transmit the DL-TDoA response message or the second sidelink message to the first wireless device based on the DL-TDoA poll message or the first sidelink message.

20. The apparatus of claim 15, wherein the at least one processor is further configured to:
receive an indication of a contention access period (CAP) from the first wireless device; and
transmit the response message to the first wireless device during the CAP.

21. The apparatus of claim 20, wherein the CAP includes multiple slots, and the at least one processor is configured to transmit the response message to the first wireless device at one of the multiple slots based on a random selection.

22. The apparatus of claim 20, wherein the CAP is further associated with a contention free period (CFP).

23. The apparatus of claim 15, wherein the at least one processor is further configured to:
receive an indication of a response transmission time within a contention free period (CFP) from the first wireless device; and
transmit the response message to the first wireless device at the response transmission time.

24. The apparatus of claim 23, wherein the CFP is further associated with a contention access period (CAP).

25. The apparatus of claim 15, wherein the at least one processor is further configured to:
receive an indication of the clock accuracy threshold, or an indication of the location confidence threshold, or both, from the first wireless device.

26. The apparatus of claim 15, wherein the at least one processor is configured to transmit the response message based on the clock accuracy value exceeding the clock accuracy threshold, the location confidence value exceeding the location confidence threshold, or both.

27. The apparatus of claim 15, wherein the at least one processor is further configured to:
estimate a position of the second wireless device based on downlink (DL)-time difference of arrival (TDoA) (DL-TDoA); and
transmit the response message based on the estimated position of the second wireless device.

28. The apparatus of claim 15, wherein the at least one processor is further configured to:
receive an indication of multiple response phases, each of the multiple response phases corresponding to a quality of service (QOS) level and including a contention free period (CFP) and a contention access period (CAP);
select one response phase from the multiple response phases based on the QoS level of the one response phase; and
transmit the response message to the first wireless device via the one response phase.

29. A method of wireless communication at a second wireless device, comprising:
transmitting a response message to a first wireless device, the response message including a clock accuracy value of the second wireless device, a location confidence value of the second wireless device, or a combination thereof; and
establishing a ranging session with the first wireless device based on the clock accuracy value of the second wireless device exceeding a clock accuracy threshold, the location confidence value of the second wireless device exceeding a location confidence threshold, or both.

30. The method of claim 29, further comprising:
estimating a position of the second wireless device based on downlink (DL)-time difference of arrival (TDoA) (DL-TDoA); and
transmitting the response message based on the estimated position of the second wireless device.
